(19) United States
(12) Patent Application Publication
(10) Pub. No.: US 2025/0239659 A1
(43) Pub. Date: Jul. 24, 2025

(54) BATTERY CONTROL SYSTEM AND VEHICLE

(71) Applicant: SEMICONDUCTOR ENERGY LABORATORY CO., LTD., Atsugi-shi, Kanagawa-ken (JP)

(72) Inventors: Takeshi OSADA, Isehara, Kanagawa (JP); Yosuke TSUKAMOTO, Atsugi, Kanagawa (JP); Haruki KATAGIRI, Atsugi, Kanagawa (JP)

(21) Appl. No.: 18/698,058

(22) PCT Filed: Oct. 3, 2022
(86) PCT No.: PCT/IB2022/059395

§ 371 Date: Apr. 3, 2024

(30) Foreign Application Priority Data
Oct. 15, 2021 (JP) 2021-169599

(51) Int. Cl. H01M 10/42; B60L 58/18; B60L 58/24; G01K 3/00; H01M 4/505; H01M 4/525; H01M 4/58; H01M 10/0525; H01M 10/054; H01M 10/0569; H01M 10/48

(52) U.S. Cl. CPC H01M 10/425; B60L 58/18; B60L 58/24; G01K 3/005; H01M 4/505; H01M 4/525; H01M 4/5825; H01M 10/0525; H01M 10/054; H01M 10/0569; H01M 10/482; H01M 10/486; B60L 2210/10; H01M 2010/4271; H01M 2220/20; H01M 2300/004

(57) ABSTRACT

A battery control system in which two or more kinds of batteries are used in an appropriate state in accordance with the temperature is provided. The battery control system includes: a first battery for normal-temperature use; a second battery for low-temperature use; a first circuit being electrically connected to the first battery and including a first transformer; a second circuit being electrically connected to the second battery and including a second transformer; and one or two or more temperature sensors configured to detect a temperature of the first battery and the second battery. When the temperature detected with the temperature sensors is higher than or equal to Tr, power of the second battery is transferred to the first battery by the first circuit and the second circuit. When the temperature detected with the temperature sensors is lower than the Tr, power of the first battery is transferred to the second battery by the first circuit and the second circuit.

### TECHNICAL FIELD

One embodiment of the present invention relates to a battery control system or a vehicle provided with a battery control system.

One embodiment of the present invention is not limited to the above technical field and relates to an electronic device provided with a battery control system. Another embodiment of the present invention is a power storage device provided with a battery control system, and the power storage device can store electric power obtained from power generation equipment such as a solar panel.

Note that one embodiment of the present invention is not limited to the above technical field, and relates to a semiconductor device, a display device, a light-emitting device, a recording device, a driving method thereof, or a manufacturing method thereof. Therefore, the technical field of one embodiment of the invention disclosed in this specification and the like relates to an object, a method, or a manufacturing method.

### BACKGROUND ART

Secondary batteries are essential for a modern society as energy sources that can be used repeatedly. A secondary battery including lithium ions as carrier ions is referred to as a lithium-ion battery, and a secondary battery including sodium ions as carrier ions is referred to as a sodium-ion battery.

For a vehicle provided with secondary batteries, a structure including a first battery that stores electric power to be supplied to a driving source and a second battery having characteristics of a higher output at low temperature than the first battery has been proposed (see Patent Document 1).

### REFERENCE

### Patent Document

[Patent Document 1] Japanese Published Patent Application No. 2020-92509

### SUMMARY OF THE INVENTION

### Problems to be Solved by the Invention

In Patent Document 1, it is described that the second battery is preferentially used over the first battery when the temperature is below a predetermined value. Although it is also described that the percentage of the first battery used and the percentage of the second battery used may be changed by the control in accordance with the temperature, the control is not specifically disclosed. In such a control system, it is important to use two kinds of batteries in an appropriate state in accordance with the temperature.

In view of the above description, one embodiment of the present invention is a battery control system including two or more kinds of batteries, and an object is to use each of the batteries in an appropriate state in accordance with the temperature. One embodiment of the present invention is a battery control system including two or more kinds of batteries, and an object is to control the output from each of the batteries in accordance with the temperature. One embodiment of the present invention is a battery control system including two or more kinds of batteries, and an object is to enable energy transmission and reception, that is, power transfer between the batteries in accordance with the temperature.

An object of one embodiment of the present invention is to efficiently use each of the batteries and inhibit an imbalance in a deterioration state. Furthermore, an object of one embodiment of the present invention is to stably supply power.

Note that the description of these objects does not preclude the existence of other objects. One embodiment of the present invention does not need to achieve all the objects. Note that other objects can be derived from the description of the specification, the drawings, and the claims (referred to as this specification and the like).

### Means for Solving the Problems

In consideration of the above description, one embodiment of the present invention is a battery control system which includes: a first battery that can be charged and discharged in a first temperature range; a second battery that can be charged and discharged in a second temperature range; a first circuit being electrically connected to the first battery and including a first transformer; a second circuit being electrically connected to the second battery and including a second transformer; and one or two or more temperature sensors configured to detect a temperature of the first battery and the second battery. When the temperature detected with the temperature sensors is higher than or equal to Tr, power of the second battery is transferred to the first battery by the first circuit and the second circuit. When the temperature detected with the temperature sensors is lower than the Tr, power of the first battery is transferred to the second battery by the first circuit and the second circuit. An upper limit of the first temperature range is higher than an upper limit of the second temperature range, a lower limit of the first temperature range is lower than the upper limit of the second temperature range, a lower limit of the second temperature range is lower than the lower limit of the first temperature range, and the Tr satisfies a range higher than the lower limit of the first temperature range and lower than the upper limit of the second temperature range.

Another embodiment of the present invention is a battery control system which includes: a first battery that can be charged and discharged in a first temperature range; a second battery that can be charged and discharged in a second temperature range; a first DCDC circuit electrically connected to the first battery; a second DCDC circuit electrically connected to the second battery; and one or two or more temperature sensors configured to detect a temperature of the first battery and the second battery. When the temperature detected with the temperature sensors is higher than or equal to Tr, an output from the first battery is set higher than an output from the second battery by the first DCDC circuit. When the temperature detected with the temperature sensors is lower than the Tr, the output from the second battery is set higher than the output from the first battery by the second DCDC circuit. An upper limit of the first temperature range is higher than an upper limit of the second temperature range, a lower limit of the first temperature range is lower than the upper limit of the second temperature range, a lower limit of the second temperature range is lower than the lower limit of the first temperature range, and the Tr satisfies a range higher than the lower limit of the first temperature range and lower than the upper limit of the second temperature range.

Another embodiment of the present invention is a battery control system which includes: a first battery that can be charged and discharged in a first temperature range; a second battery that can be charged and discharged in a second temperature range; a first circuit being electrically connected to an input side of the first battery and including a first transformer; a second circuit being electrically connected to an input side of the second battery and including a second transformer; a first DCDC circuit electrically connected to an output side of the first battery; a second DCDC circuit electrically connected to an output side of the second battery; and one or two or more temperature sensors configured to detect a temperature of the first battery and the second battery. When the temperature detected with the temperature sensors is higher than or equal to Tr, an output from the first battery is set higher than an output from the second battery by the first DCDC circuit. When the temperature detected with the temperature sensors is lower than the Tr, the output from the second battery is set higher than the output from the first battery by the second DCDC circuit. When the temperature detected with the temperature sensors is higher than or equal to the Tr, power of the second battery is transferred to the first battery by the first circuit and the second circuit. When the temperature detected with the temperature sensors is lower than the Tr, power of the first battery is transferred to the second battery by the first circuit and the second circuit. An upper limit of the first temperature range is higher than an upper limit of the second temperature range, a lower limit of the first temperature range is lower than the upper limit of the second temperature range, a lower limit of the second temperature range is lower than the lower limit of the first temperature range, and the Tr satisfies a range higher than the lower limit of the first temperature range and lower than the upper limit of the second temperature range.

In one embodiment of the present invention, a discharge capacity value of the second battery in discharge at the lower limit of the second temperature range is preferably higher than or equal to 50% of a discharge capacity value of the second battery in discharge at 25° C.

In one embodiment of the present invention, the first battery is preferably a lithium-ion battery and the second battery is preferably a sodium-ion battery.

In one embodiment of the present invention, a positive electrode active material of the first battery preferably has a layered rock-salt crystal structure and a positive electrode active material of the second battery preferably has an olivine crystal structure.

In one embodiment of the present invention, a positive electrode active material of the first battery preferably contains Li, Ni, Co, and Mn and a positive electrode active material of the second battery preferably contains Li, Fe, and phosphorus.

In one embodiment of the present invention, a median diameter of a positive electrode active material of the second battery is preferably smaller than a median diameter of a positive electrode active material of the first battery.

In one embodiment of the present invention, an electrolyte of the second battery is preferably different from an electrolyte of the first battery; the electrolyte of the second battery preferably contains ethylene carbonate (EC), ethyl methyl carbonate (EMC), and dimethyl carbonate (DMC); and when a total content of the ethylene carbonate, the ethyl methyl carbonate, and the dimethyl carbonate is 100 vol %, a volume ratio between the ethylene carbonate, the ethyl methyl carbonate, and the dimethyl carbonate is preferably x:y:100−x−y (where 5≤x≤35 and 0<y<65).

One embodiment of the present invention is a vehicle including the above-described battery control system.

### Effect of the Invention

With a battery control system of one embodiment of the present invention, each battery can be used in an appropriate state in accordance with the temperature. With a battery control system of one embodiment of the present invention, the output from each battery can be controlled in accordance with the temperature. With a battery control system that is one embodiment of the present invention, energy transmission and reception, that is, power transfer between batteries in accordance with the temperature is possible.

With one embodiment of the present invention described above, each of the batteries can be efficiently used and an imbalance in a deterioration state can be inhibited. Furthermore, with one embodiment of the present invention described above, power can be stably supplied.

Note that the description of these effects does not preclude the existence of other effects. One embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are diagrams each illustrating a battery control system that is one embodiment of the present invention.

FIG. 2 is a diagram illustrating a battery control system that is one embodiment of the present invention.

FIG. 3A and FIG. 3B are diagrams illustrating a battery control system that is one embodiment of the present invention.

FIG. 4A and FIG. 4B are diagrams illustrating a battery control system that is one embodiment of the present invention.

FIG. 5 is a diagram illustrating a battery control system that is one embodiment of the present invention.

FIG. 6 is a diagram illustrating a battery control system that is one embodiment of the present invention.

FIG. 7A to FIG. 7E are diagrams illustrating a battery control system that is one embodiment of the present invention.

FIG. 8A and FIG. 8B are diagrams each illustrating a battery control system that is one embodiment of the present invention.

FIG. 9A and FIG. 9B are diagrams each illustrating a battery control system that is one embodiment of the present invention.

FIG. 10 is a diagram illustrating a battery control system that is one embodiment of the present invention.

FIG. 11A and FIG. 11B are diagrams illustrating an electric vehicle provided with a battery control system that is one embodiment of the present invention.

FIG. 12 is a diagram illustrating an example in which a battery control system is used in an electric vehicle that is one embodiment of the present invention.

FIG. 13 is a diagram illustrating an example in which a battery control system is used in an electric vehicle that is one embodiment of the present invention.

FIG. 14 is a diagram illustrating an example in which a battery control system is used in an electric vehicle that is one embodiment of the present invention.

FIG. 15A and FIG. 15B are diagrams each illustrating a positive electrode that is one embodiment of the present invention.

FIG. 16 is a diagram illustrating a method for forming a positive electrode active material that is one embodiment of the present invention.

FIG. 17 is a diagram illustrating a method for forming a positive electrode active material that is one embodiment of the present invention.

FIG. 18 is a diagram illustrating a method for forming a positive electrode active material that is one embodiment of the present invention.

FIG. 19A and FIG. 19B are diagrams each illustrating a battery that is one embodiment of the present invention.

FIG. 20A and FIG. 20B are diagrams each illustrating a laminated cell that is one embodiment of the present invention.

FIG. 21A and FIG. 21B are diagrams illustrating a method for manufacturing a laminated cell that is one embodiment of the present invention.

FIG. 22A to FIG. 22C are diagrams each illustrating a battery cell that is one embodiment of the present invention.

FIG. 23A to FIG. 23C are diagrams illustrating a battery cell that is one embodiment of the present invention.

FIG. 24A to FIG. 24D are diagrams each illustrating a cylindrical battery cell that is one embodiment of the present invention.

FIG. 25A to FIG. 25C are diagrams each illustrating a vehicle that is one embodiment of the present invention.

### MODE FOR CARRYING OUT THE INVENTION

Examples of embodiments of the present invention will be described in detail below with reference to the drawings and the like. Note that the present invention should not be interpreted as being limited to the examples of embodiments given below. Embodiments of the invention can be changed unless it deviates from the spirit of the present invention.

### Embodiment 1

In this embodiment, a battery control system of one embodiment of the present invention is described.

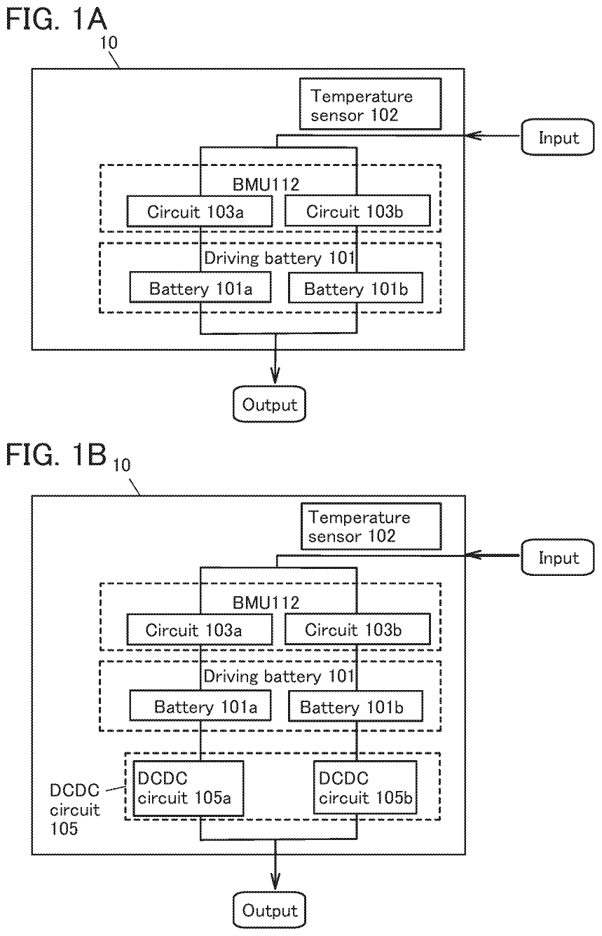

As illustrated in FIG. 1A, a battery control system 10 of one embodiment of the present invention includes at least a driving battery 101, a temperature sensor 102, and a battery management unit (also referred to as a BMU) 112.

The battery control system 10 in FIG. 1B includes at least the driving battery 101, the temperature sensor 102, the BMU 112, and a DCDC circuit 105.

### Structure Example 1 of Battery Control System

In the battery control system 10 of one embodiment of the present invention, the driving battery 101 includes two kinds of batteries 101a and 101b. For example, the battery 101a can be a battery for normal-temperature use that has excellent battery characteristics at normal temperature or middle temperature, and the battery 101b can be a battery for low-temperature use that has excellent battery characteristics at low temperature. The battery for normal-temperature use can be charged and discharged in a first temperature range although the details of the battery for normal-temperature use are described later. The battery for low-temperature use can be charged and discharged in a second temperature range although the details of the battery for low-temperature use are described later. The battery control system 10 of one embodiment of the present invention can control the two kinds of batteries in the following manner.

When it is determined using the temperature sensor 102 that the temperature of the driving battery 101 or the like is higher than or equal to Tr, the battery control system 10 of one embodiment of the present invention performs control so that power of the battery 101b is transferred to the battery 101a. When it is determined using the temperature sensor 102 that the temperature of the driving battery 101 or the like is lower than Tr, the battery control system 10 that is one embodiment of the present invention performs control so that power of the battery 101a is transferred to the battery 101b. Details of the temperature sensor are described later.

The range of the above-described temperature Tr can be determined on the basis of the temperature ranges where the battery for normal-temperature use and the battery for low-temperature use can be charged and discharged. Specifically, Tr preferably satisfies a range higher than the lower limit of the first temperature range where the battery for normal-temperature use can be charged and discharged and lower than the upper limit of the second temperature range where the battery for low-temperature use can be charged and discharged.

As the temperature gets lower, the output form the battery for normal-temperature use or the like becomes lower. Therefore, on the basis of the percentage of the output lowered, the range of the temperature Tr can be determined. For example, Tr preferably satisfies a range lower than the temperature of the time when the output of the battery for normal-temperature use is lowered to 80% of the maximum output of the battery and higher than the lower limit of the chargeable and dischargeable temperature range. Note that the percentage of the output lowered with respect to the maximum output mentioned by the above numerical value can be determined freely, and the percentage is preferably any one value that is higher than or equal to 70% and lower than or equal to 95%.

Specifically, the temperature Tr is any one temperature that is higher than or equal to −40° C. and lower than or equal to 85° C., preferably higher than or equal to −20° C. and lower than or equal to 45° C.

In the battery control system 10 of one embodiment of the present invention, the above-described control can be performed using a circuit including a transformer or the like. The circuit including the transformer or the like is preferably provided in the BMU 112.

With such an embodiment of the present invention, power transmission and reception, that is, power transfer between batteries in accordance with the temperature is possible. Consequently, each battery can be used in an appropriate state in accordance with the temperature. Furthermore, an imbalance in a deterioration state between the batteries can be inhibited, and power can be supplied more stably.

### Structure Example 2 of Battery Control System

The battery control system 10 of one embodiment of the present invention can control the above-described two kinds of batteries in the following manner as well.

When it is determined using the temperature sensor 102 that the temperature of the driving battery 101 or the like is Tr, the battery control system 10 of one embodiment of the present invention can perform control so that the output from the battery 101a is higher than the output from the battery 101b. Note that in this specification and the like, the output from the battery may be rephrased as power of the battery. When it is determined using the temperature sensor 102 that the temperature of the driving battery 101 or the like is lower than Tr, the battery control system 10 of one embodiment of the present invention can perform control so that the output from the battery 101b is higher than the output from the battery 101a.

The temperature Tr is as described in <Structure example 1 of battery control system>.

In the battery control system 10 of one embodiment of the present invention, the above-described control is possible using the DCDC circuit 105. Typically, the above-described control is possible using a switch (SW) included in the DCDC circuit 105.

Furthermore, if there is a difference between the output voltage from the battery 101a and the output voltage from the battery 101a, the DCDC circuit 105 preferably has a function of setting the output voltages equal to each other.

With such an embodiment of the present invention, the output from each battery can be controlled in accordance with the temperature. Consequently, each battery can be used in an appropriate state in accordance with the temperature. Furthermore, an imbalance in a deterioration state between the batteries can be inhibited, and power can be supplied more stably.

### Structure Example 3 of Battery Control System

The battery control system 10 of one embodiment of the present invention can control the above-described two kinds of batteries in the following manner as well.

For example, after control is performed so that the outputs from the batteries are different in accordance with the temperature Tr as in <Structure example 2 of battery control system>, control may be performed so that power is transferred between the batteries in accordance with the temperature Tr as in <Structure example 1 of battery control system>.

Furthermore, for example, after power is transferred between the batteries in accordance with the temperature Tr as in <Structure example 1 of battery control system>, control may be performed so that the outputs from the batteries are different in accordance with the temperature Tr as in <Structure example 2 of battery control system>.

The temperature Tr is as described in <Structure example 1 of battery control system>.

With such an embodiment of the present invention, each battery can be used in an appropriate state in accordance with the temperature. Furthermore, an imbalance in a deterioration state between the batteries can be inhibited, and power can be supplied more stably.

Next, the structures illustrated in FIG. 1A and FIG. 1B are described.

### Driving Battery

As illustrated in FIG. 1A, FIG. 1B, and the like, the battery control system 10 that is one embodiment of the present invention includes the driving battery 101. In this embodiment, at least two kinds of batteries 101a and 101b are used as the driving battery 101. The ordinal numbers such as first and second are sometimes used to distinguish the battery 101a and the battery 101b from each other.

In the battery control system 10 that is one embodiment of the present invention, two or more kinds of batteries are included; for example, three kinds of batteries may be included. That is, as the two kinds of batteries described above in <Structure examples 1 and 2 of battery control system>, two or more kinds of batteries, for example, three kinds of batteries may be used. When the number of kinds of batteries are increased, the number of temperatures corresponding to the temperature Tr described in the above-described structure examples 1 to 3 can be increased.

For example, when three kinds of batteries such as the battery 101a to a battery 101c are used, the following control is possible in <Structure example 1 of battery control system>.

When it is determined using the temperature sensor 102 that the temperature of the driving battery 101 or the like is higher than or equal to Tr1, the battery control system 10 of one embodiment of the present invention performs control so that power of one or both of the battery 101b and the battery 101c is transferred to the battery 101a. When it is determined using the temperature sensor 102 that the temperature of the driving battery 101 or the like is lower than Tr1 and higher than or equal to Tr2, the battery control system 10 of one embodiment of the present invention performs control so that power of one or both of the battery 101a and the battery 101c is transferred to the battery 101b. When it is determined using the temperature sensor 102 that the temperature of the driving battery 101 or the like is lower than Tr2, the battery control system 10 that is one embodiment of the present invention can perform control so that power of one or both of the battery 101a and the battery 101b is transferred to the battery 101c.

The temperatures Tr1 and Tr2 are determined on the basis of the temperature range in which the battery for normal-temperature use can be charged and discharged; the temperature Tr1 is lower than Tr2, and the specific temperatures Tr1 and Tr2 are each preferably any one temperature that is higher than or equal to −40° C. and lower than or equal to 85° C., further preferably any one temperature that is higher than or equal to −20° C. and lower than or equal to 45° C.

The temperatures Tr1 and Tr2 are determined on the basis of the temperature range in which the battery for normal-temperature use can be charged and discharged and can be, for example, the temperature of the time when the output of the battery for normal-temperature use is 60% of the maximum output and the temperature of the time when the output of the battery for normal-temperature use is 80% of the maximum output. Note that 60% and 80% are specifications of the battery control system 10, and the percentages to the maximum output can be determined freely.

For example, when three kinds of batteries such as the battery 101a to the battery 101c are used, the following control is possible in <Structure example 2 of battery control system>.

When it is determined using the temperature sensor 102 that the temperature of the driving battery 101 or the like is higher than or equal to Tr1, the battery control system 10 that is one embodiment of the present invention can perform control so that the output from the battery 101a is higher than the output from the battery 101b or the battery 101c. When it is determined using the temperature sensor 102 that the temperature of the driving battery 101 or the like is lower than Tr1 and higher than or equal to Tr2, the battery control system 10 that is one embodiment of the present invention can perform control so that the output from the battery 101b is higher than the output from the battery 101a or the battery 101c. When it is determined using the temperature sensor 102 that the temperature of the driving battery 101 or the like is lower than Tr2, the battery control system 10 that is one embodiment of the present invention can perform control so that the output from the battery 101c is higher than the output from the battery 101a or the battery 101b.

The temperatures Tr1 and Tr2 are determined on the basis of the temperature range in which the battery for normal-temperature use can be charged and discharged; the temperature Tr1 is lower than Tr2, and the specific temperatures Tr1 and Tr2 are each preferably any one temperature that is higher than or equal to −40° C. and lower than or equal to 85° C., further preferably any one temperature that is higher than or equal to −20° C. and lower than or equal to 45° C.

The temperatures Tr1 and Tr2 are determined on the basis of the temperature range in which the battery for normal-temperature use can be charged and discharged and can be, for example, the temperature of the time when the output of the battery for normal-temperature use is 60% of the maximum output and the temperature of the time when the output of the battery for normal-temperature use is 80% of the maximum output. Note that 60% and 80% are specifications of the battery control system 10, and the percentages to the maximum output can be determined freely.

For example, when three kinds of batteries such as the battery 101a to the battery 101c are used, the temperatures Tr1 and Tr2 can be used also in <Structure example 3 of battery control system> in a manner similar to the above.

Thus, the driving battery 101 includes two or more kinds of batteries.

Each of the battery 101a and the battery 101b included in the driving battery 101 preferably includes an assembled battery. The assembled battery includes a plurality of battery cells. Alternatively, the battery 101a and the battery 101b may each include a single battery cell (also simply referred to as a battery cell). In the case where an assembled battery is used as each of the battery 101a and the battery 101b, the battery control system 10 of one embodiment of the present invention is preferably used for an electric vehicle (EV), a power storage device, or the like. Note that the EV is described later. In the case where a battery cell is used as each of the battery 101a and the battery 101b, the battery control system 10 of one embodiment of the present invention is preferably used for an electronic device such as a smartphone.

### Battery for Normal-Temperature Use

Of the two kinds of batteries described as an example in the battery control system 10 of one embodiment of the present invention, one is a battery for normal-temperature use and the other is a battery for low-temperature use.

For example, as the battery 101a used as the battery for normal-temperature use, a battery that can be charged and discharged at normal temperature or middle temperature is used. That is, the battery 101a can be charged and discharged in the first temperature range, and the first temperature range is preferably higher than or equal to 0° C. and lower than or equal to +85° C., further preferably higher than or equal to +5° C. and lower than or equal to +65° C., still further preferably higher than or equal to +5° C. and lower than or equal to +45° C., yet still further preferably higher than or equal to +5° C. and lower than or equal to +35° C.

The capability of being charged and discharged means that cycle performance can be obtained at the above-described temperature, and the battery 101a preferably has favorable cycle performance at the above-described temperature. The cycle performance is, when charging and discharging are regarded as one cycle, performance obtained from a test of repeatedly performing the cycle a plurality of times, e.g., 200 times, under predetermined conditions (also referred to as a cycle test) and sometimes represented by discharge capacity as a function of the number of cycles or the retention rate of discharge capacity. As the retention rate of discharge capacity, the rate of discharge capacity at the final cycle, e.g., the 200-th cycle to the maximum discharge capacity is sometimes evaluated; the cycle performance is favorable when the retention rate satisfies 80% or higher, preferably 90% or higher, further preferably 95% or higher, further preferably 98% or higher. Although the battery on which the cycle test is performed may have either a half cell or full cell configuration, a cycle test is preferably performed on a full cell in this embodiment.

At a temperature lower than the lower limit of the first temperature range, the battery for normal-temperature use cannot be charged and discharged or, even if charging and discharging are possible, enough discharge capacity cannot be obtained. Incapability of obtaining enough discharge capacity includes a case where the retention rate of discharge capacity, which represents cycle performance, is lower than 50%, for example.

At a temperature higher than the upper limit of the first temperature range, the battery for normal-temperature use cannot be charged and discharged or, even if charging and discharging are possible, enough discharge capacity cannot be obtained. Incapability of obtaining enough discharge capacity includes a case where the retention rate of discharge capacity, which represents cycle performance, is lower than 50%, for example.

### Battery for Low-Temperature Use

A battery for low-temperature use has different battery characteristics from a battery for normal-temperature use. For example, as the battery 101b used as the battery for low-temperature use, a battery that can be charged and discharged at low temperature is used. That is, the battery 101b can be charged and discharged in the second temperature range, and the second temperature range is preferably lower than 0° C. and higher than or equal to −40° C., further preferably lower than −5° C. and higher than or equal to −30° C., still further preferably lower than −10° C. and higher than or equal to −20° C.

The relation between the above-described first temperature range and the above-described second temperature range is preferably as follows: the upper limit of the first temperature range is higher than the upper limit of the second temperature range, the lower limit of the first temperature range is lower than the upper limit of the second temperature range, and the lower limit of the second temperature range is lower than the lower limit of the first temperature range.

The capability of being charged and discharged means that cycle performance can be obtained at the above-described temperature. Although the battery on which the cycle test is performed may have either a half cell or full cell configuration, a cycle test is preferably performed on a full cell in this embodiment.

The discharge capacity in an environment at 0° C. or lower, preferably −20° C. or lower, further preferably −40° C. or lower, that is, the discharge capacity value at the lower limit of the second temperature range, which represents discharge characteristics, of the battery that can be charged and discharged at low temperature is preferably higher than or equal to 50%, further preferably higher than or equal to 60%, further preferably higher than or equal to 70%, further preferably higher than or equal to 80%, further preferably higher than or equal to 90%, further preferably higher than or equal to 95% of the discharge capacity value in an environment at 25° C. Although the battery on which a discharge test is performed may have either a half cell or full cell configuration, a discharge test is preferably performed on a full cell in this embodiment.

At a temperature lower than the lower limit of the second temperature range, the battery for low-temperature use cannot be charged and discharged or, even if charging and discharging are possible, enough discharge capacity cannot be obtained. Incapability of obtaining enough discharge capacity includes a case where the retention rate of discharge capacity, which represents cycle performance, is lower than 50%, for example.

At a temperature higher than the upper limit of the second temperature range, the battery for low-temperature use cannot be charged and discharged or, even if charging and discharging are possible, enough discharge capacity cannot be obtained. Incapability of obtaining enough discharge capacity includes a case where the retention rate of discharge capacity, which represents cycle performance, is lower than 50%, for example.

Thus, the battery 101a preferably has different battery characteristics from the battery 101b. In other words, the temperature range in which the battery 101a can be charged and discharged is different from the temperature range in which the battery 101b can be charged and discharged. Including two or more kinds of batteries with different chargeable and dischargeable temperature ranges is preferable in order that the driving battery 101 can be charged and discharged in a wide temperature range.

A lithium-ion battery can be used as the battery for normal-temperature use satisfying the above-described battery characteristics, and a sodium-ion battery can be used as the battery for low-temperature use satisfying the above-described battery characteristics. That is, as the battery for normal-temperature use, a battery with different carrier ions from the battery for low-temperature use may be used.

Alternatively, a combination of lithium-ion batteries may be used as the batteries satisfying the above-described battery characteristics. In this case, a lithium composite oxide containing Ni, Mn, and Co (sometimes referred to as NCM) can be used as a positive electrode active material of the battery for normal-temperature use, and LiFePO₄ having an olivine crystal structure (sometimes referred to as LFP) can be used as a positive electrode active material of the battery for low-temperature use. Alternatively, LFP can be used as the positive electrode active material of the battery for normal-temperature use, and NCM can be used as the positive electrode active material of the battery for low-temperature use. NCM and LFP will be described later. That is, as the battery for normal-temperature use, a lithium-ion battery whose positive electrode active material is different from the positive electrode active material of the battery for low-temperature use may be used.

In the case where a combination of lithium-ion batteries is used, the same kind of positive electrode active material may be used. In that case, the particle diameter of the positive electrode active material of the battery for normal-temperature use and the particle diameter of the positive electrode active material of the battery for low-temperature use are preferably different from each other. For example, the particle diameter of the positive electrode active material of the battery for low-temperature use is preferably smaller than that of the positive electrode active material of the battery for normal-temperature use. Here, a median diameter (D50) can be used as the particle diameter, for example.

In the case where a combination of lithium-ion batteries is used and the same kind of positive electrode active material is used, different organic solvents may be used. In that case, an organic solvent suitable for the battery for normal-temperature use (sometimes referred to as an organic solvent for normal-temperature use) is preferably used, and an organic solvent suitable for the battery for low-temperature use (sometimes referred to as an organic solvent for low-temperature use) is preferably used. That is, as the battery for normal-temperature use, a lithium-ion battery whose organic solvent is different from the organic solvent of the battery for low-temperature use may be used.

As described above, in one embodiment of the present invention, two or more kinds of batteries having different battery characteristics in accordance with the temperature are used; thus, the driving battery 101 can operate in a wide temperature environment.

Furthermore, in one embodiment of the present invention, heat generated from one of the two or more kinds of batteries may be used as a heat source to heat the other battery. For example, when the battery for low-temperature use is charged or discharged in a low-temperature environment, the battery for low-temperature use generates heat. With the use of the heat, the battery for normal-temperature use can be heated in a low-temperature environment. After the battery for normal-temperature use is heated up, for example, after the temperature of the battery for normal-temperature use becomes higher than or equal to 0° C., the battery for normal-temperature use is preferably made to operate. The battery operation includes at least charging and discharging.

### Temperature Sensor

As illustrated in FIG. 1A, FIG. 1B, and the like, the battery control system 10 of one embodiment of the present invention includes the temperature sensor 102. The temperature sensor 102 is preferably provided at a position where the temperature of the driving battery 101 can be detected.

The battery control system 10 that is one embodiment of the present invention is preferably capable of detecting the temperature of the battery 101a and the temperature of the battery 101b and is preferably provided with at least two or more temperature sensors 102. In the case where two or more temperature sensors 102 are provided, detection of the average temperature is also possible.

For example, in the case where the battery 101a and the battery 101b are stored in the same housing as a battery pack, the temperature of the battery 101a and the temperature of the battery 101b can be detected when one or more temperature sensors 102 are positioned in contact with the housing. In the case where a housing stored underneath an automobile is provided with two or more temperature sensors, the temperature sensors are provided at a position on the low-temperature side that is close to outside air and a position on the high-temperature side that is close to the inside of the automobile. In this manner, arranging two or more temperature sensors on the low-temperature side and the high-temperature side is preferable for easily controlling the temperature of the batteries.

Moreover, for a housing with no or small temperature distribution, one temperature sensor 102 is provided.

In the case where a thermistor is used as the above-described temperature sensor 102, a contact portion of the thermistor is made to be in contact with the driving battery 101, so that a change in resistance value of the contact portion can be detected and the temperature of the driving battery 101 can be calculated on the basis of the resistance value. The driving battery 101 can be rephrased as the battery 101a, the battery 101b, or the housing of the battery pack.

### BMU

As illustrated in FIG. 1A, FIG. 1B, and the like, the battery control system 10 that is one embodiment of the present invention includes the BMU 112.

Since the BMU 112 is electrically connected to the driving battery 101 and the driving battery 101 includes the battery 101a and the battery 101b in this embodiment, the BMU 112 includes a circuit 103a corresponding to the battery 101a and a circuit 103b corresponding to the battery 101b. That is, the BMU 112 includes the circuit 103a and the circuit 103b corresponding to the batteries included in the driving battery 101.

As described above in <Structure example 1 of battery control system>, power can be transferred between the battery 101a and the battery 101b in accordance with the temperature by the circuit 103a, the circuit 103b, and the like included in the BMU 112. For the transfer, each of the circuit 103a and the circuit 103b preferably includes a transformer and a switch electrically connected to the transformer. The transformer electrically connected to the input side of the battery has a structure in which a primary coil and a secondary coil wind around a common iron wire, and when a current is fed to one of the coils, induced electromotive force can be generated in the other coil. A current fed to one of the coils is controlled by the switch electrically connected to the one of the coils. Specifically, when the switch is turned on, a constant current is fed to one of the coils; thus, on/off of the switch are repeated until the current reaches a current corresponding to the transfer amount between the batteries.

In the case where power of the battery 101a is transferred to the battery 101b, a current corresponding to the transfer amount is supplied to the circuit 103b through the circuit 103a and then supplied to the battery 101b through the circuit 103b. In the case where power of the battery 101b is transferred to the battery 101a, a current corresponding to the transfer amount is supplied to the circuit 103a through the circuit 103b and then supplied to the battery 101a through the circuit 103a.

Note that the circuit 103a and the circuit 103b may be provided in another unit without being provided in the BMU 112. Specific structures and the like of the circuit 103a and the circuit 103b are described later.

### DCDC Circuit

Unlike in FIG. 1A, the battery control system 10 illustrated in FIG. 1B includes the DCDC circuit 105.

The DCDC circuit 105 is electrically connected to the driving battery 101 and includes the two kinds of batteries 101a and 101b in this embodiment; thus, the DCDC circuit 105 includes a DCDC circuit 105a corresponding to the battery 101a and a DCDC circuit 105b corresponding to the battery 101b. That is, the DCDC circuit 105 includes the DCDC circuit 105a and the DCDC circuit 105b which correspond to the batteries included in the driving battery 101 and are electrically connected to the output side of the batteries.

As described above in <Structure example 2 of battery control system>, the output from the battery 101a can be set higher than the output from the battery 101b by the DCDC circuit 105a and the DCDC circuit 105b. For the settings, each of the DCDC circuit 105a and the DCDC circuit 105b preferably includes at least a coil and a switch electrically connected to the coil. The other specific examples of the DCDC circuit 105a and the DCDC circuit 105b are described later.

Furthermore, the output voltages from the battery 101a and the battery 101b can be set equal to each other with the DCDC circuit 105.

Although setting the outputs from batteries different in accordance with the temperature is described above in <Structure example 2 of battery control system>, in the case where the output voltages from the batteries are set equal to each other by the DCDC circuit 105, if the output current of the battery 101a is different from the output current of the battery 101b, the outputs from the batteries can be set different in accordance with the temperature. For different output currents, each of the DCDC circuit 105a and the DCDC circuit 105b preferably includes the coil and the switch electrically connected to the coil described above.

### Specific Example of Battery Control System

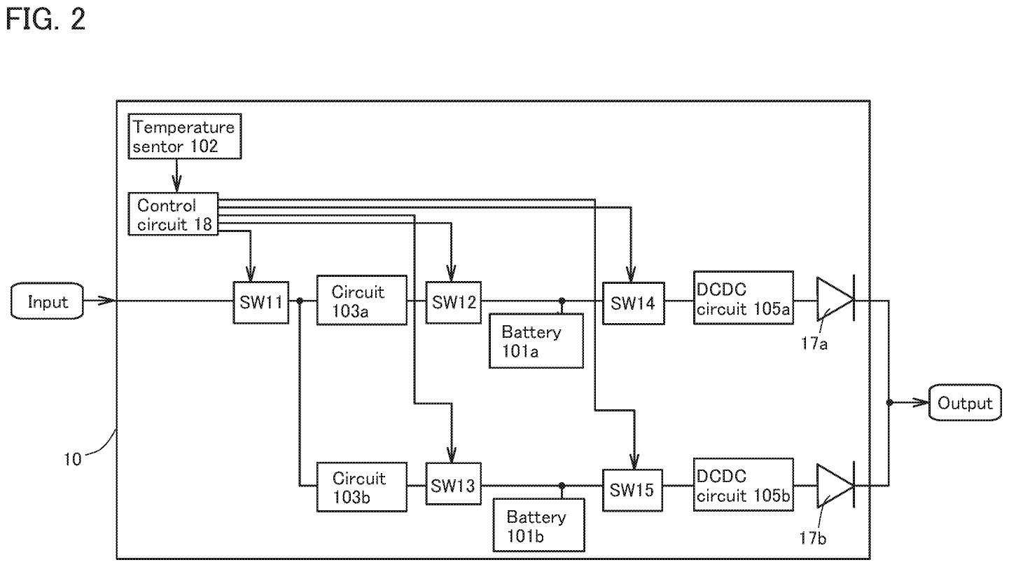

Next, FIG. 2 illustrates a specific example of the battery control system 10 illustrated in FIG. 1B.

The battery control system 10 preferably includes a control circuit 18 to which a signal from the temperature sensor 102 is input and a SW11 to a SW15, in addition to the components illustrated in FIG. 1B. Although the control circuit 18 is provided in the battery control system in FIG. 2, without limitation thereto, the control circuit 18 may be provided outside the control system 10. For example, the control circuit 18 may be provided in an ECU (Electronic Control Unit).

In the case where a thermistor is used as the temperature sensor 102 as described above, a signal regarding the resistance value is input to the control circuit 18, and the control circuit 18 can detect the temperature corresponding to the resistance value. A structure example of the temperature sensor using a thermistor is described later.

Next, structures of the SW11 to the SW15 and the like are described with reference to FIG. 2. The SW11 is preferably positioned between the input and the circuit 103a and between the input and the circuit 103b, the SW12 is preferably positioned between the circuit 103a and the battery 101a, and the SW13 is preferably positioned between the circuit 103b and the battery 101b. The SW14 is preferably positioned between the battery 101a and the DCDC circuit 105a, and the SW15 is preferably positioned between the battery 101b and the DCDC circuit 105b. The SW11 to the SW15 described above are controlled by the control circuit 18. Specifically, on or off of the SW11 to the SW15 is controlled in accordance with the above-described temperature input to the control circuit 18. Switching elements such as transistors can be used as the SW11 to the SW15.

### In Charging

A case where the battery 101a and the battery 101b are charged is described. At least the SW11 and the SW12 are on when the battery 101a is charged in accordance with the temperature obtained by the temperature sensor 102. When the battery 101b is charged in accordance with the temperature obtained by the temperature sensor 102, at least the SW11 and the SW13 are on. In the battery control system 10 that is one embodiment of the present invention, the battery 101a can be charged through the circuit 103a, and the battery 101b can be charged through the circuit 103b. Note that the SW14 and the SW15 are preferably off during charging.

It is also possible to preferentially charge the battery 101a in accordance with the above-described temperature, specifically, at 25° C. or higher. In this case, for example, the SW11 and the SW12 are in the on state and the SW13 is in the off state. In the case where the battery 101a is charged at 25° C. or higher, the battery 101b can also be charged by cooling the battery 101b at the same time as the charging, just before the charging, or just after the charging. Note that 25° C. is an exemplary temperature.

In the case where the battery 101a is preferentially charged in accordance with the above-described temperature and in the case where heat is generated from the battery 101a whose charging starts earlier, the battery 101b charged later using the heat can be heated up, which is preferable. In the heating, the temperature is preferably managed in consideration of the battery characteristics of the battery 101b.

It is also possible to preferentially charge the battery 101b in accordance with the above-described temperature, specifically, at −10° C. or lower. In this case, for example, the SW11 and the SW13 are in the on state and the SW12 is in the off state. In the case where the battery 101b is charged at −10° C. or lower, the battery 101a can also be charged by heating the battery 101a at the same time as the charging, just before the charging, or just after the charging. Note that −10° C. is an exemplary temperature.

In the case where the battery 101b is preferentially charged in accordance with the above-described temperature and in the case where heat is generated from the battery 101b whose charging starts earlier, the battery 101a charged later using the heat can be heated up, which is preferable. In the heating, the temperature is preferably managed in consideration of the battery characteristics of the battery 101a.

Furthermore, either of the battery 101a and the battery 101b can be charged first. For example, if one of the battery 101a and the battery 101b can be charged fast, the one battery is charged preferentially, so that the other battery can be charged later.

In this way, the battery control system 10 of one embodiment of the present invention can charge each of the batteries in an appropriate state in accordance with the temperature.

### In Discharging

Next, a case where the battery 101a and the battery 101b are discharged is described. At least the SW14 is on when the battery 101a is discharged in accordance with the temperature obtained by the temperature sensor 102. When the battery 101b is discharged in accordance with the temperature obtained by the temperature sensor 102, at least the SW15 is on. Note that during discharging, at least the SW12 and the SW13 are preferably off and the SW11 may be either on or off.

As described above in <Structure example 2 of battery control system>, the battery control system 10 can perform control so that the output from the battery 101a is different from the output from the battery 101b using the DCDC circuit 105a and the DCDC circuit 105 in accordance with the temperature. The output from the battery may be rephrased as discharge from the battery. Furthermore, the output voltage from the battery 101a and the output voltage from the battery 101b can be set equal to each other by the DCDC circuit 105a and the DCDC circuit 105b.

Moreover, it is also possible to discharge only the battery 101a in accordance with the temperature. In this case, for example, the SW14 is on and the SW15 is off. Furthermore, it is also possible to discharge only the battery 101b in accordance with the temperature. In this case, for example, the SW15 is on and the SW14 is off.

In this way, the battery control system 10 of one embodiment of the present invention can discharge each of the batteries in an appropriate state in accordance with the temperature.

### In Transferring

Next, a case where power of one of the battery 101a and the battery 101b is transferred to the other is described. In order to transfer the output from the battery 101a to the battery 101b in accordance with the temperature obtained by the temperature sensor 102, the SW12 and the SW13 are turned on so that the battery 101a and the battery 101b are electrically connected to each other through the circuit 103a and the circuit 103b. Also in the case where the output from the battery 101a is transferred to the battery 101b in accordance with the temperature obtained by the temperature sensor 102, the SW12 and the SW13 are turned on. During the transfer, at least the SW11, the SW14, and the SW15 are preferably off.

Power of the battery 101b can be transferred to the battery 101a in accordance with the above-described temperature. For example, part or whole of the power of the battery 101b can be transferred to the battery 101a.

Power of the battery 101a can be transferred to the battery 101b in accordance with the above-described temperature. For example, part or whole of the power of the battery 101a can be transferred to the battery 101b.

In this way, the battery control system 10 of one embodiment of the present invention can use each of the batteries in an appropriate state in accordance with the temperature.

### Diode

Furthermore, the battery control system 10 of one embodiment of the present invention preferably includes a diode 17a and a diode 17b. As illustrated in FIG. 2, the diode 17a is preferably positioned between the DCDC circuit 105a and the output. With the diode 17a, a current flow, that is, the output direction can be limited to only one direction. Similarly, the diode 17b is preferably positioned between the DCDC circuit 105b and the output. With the diode 17b, a current flow, that is, the output direction can be limited to only one direction.

Although a specific example of the battery control system 10 illustrated in FIG. 1B has been described with reference to FIG. 2, the battery control system 10 in which at least the DCDC circuit 105a, the DCDC circuit 105b, and the like are omitted from FIG. 2 corresponds to the battery control system 10 illustrated in FIG. 1A. That is, the battery control system 10 illustrated in FIG. 1A preferably includes the SW14, the SW15, the diode 17a, and the diode 17b.

### Structure Example of Temperature Sensor Using Thermistor

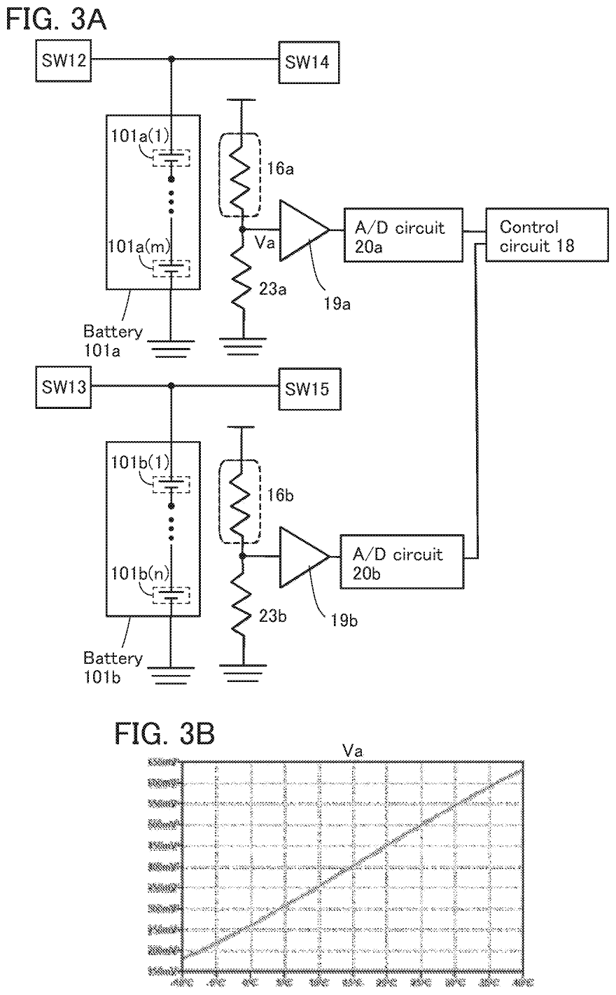

Next, a structure in which a thermistor, typically an NTC thermistor is used as the temperature sensor 102 is described. For example, as illustrated in FIG. 3A, a thermistor 16a is preferably positioned in the vicinity of or in contact with the battery 101a. Preferably, the contact portion of the thermistor 16a is in contact with the battery 101a. In FIG. 3A, the thermistor 16a is electrically connected to a resistor 23a. By resistance division with two resistors, a change in the resistance value of the thermistor 16a can be detected. Since resistance division is used, the thermistor 16a is preferably electrically connected to a wiring having a constant potential.

Furthermore, a buffer amplifier 19a is electrically connected to the thermistor 16a, and a signal can be amplified by the buffer amplifier 19a. An output from the buffer amplifier 19a is converted into a digital signal through an analog-digital converter circuit (A/D circuit) 20a and is input to the control circuit 18.

The battery 101b and a thermistor 16b can similarly have the structure regarding the temperature sensor 102.

Specifically, a voltage (denoted by Va in FIG. 3A) can be detected with the above-described thermistor 16a, and data regarding the temperature on the horizontal axis and the voltage (Va) on the vertical axis can be obtained as illustrated in FIG. 3B, for example. The control circuit 18 can control the temperature of the battery 101a on the basis of such data.

Similarly, also with the thermistor 16b, data like that illustrated in FIG. 3B can be obtained, and the control circuit 18 can control the temperature of the battery 101b.

Furthermore, by combining data of the thermistor 16a and data of the thermistor 16b, the average temperature of the battery 101a and the battery 101b can be obtained.

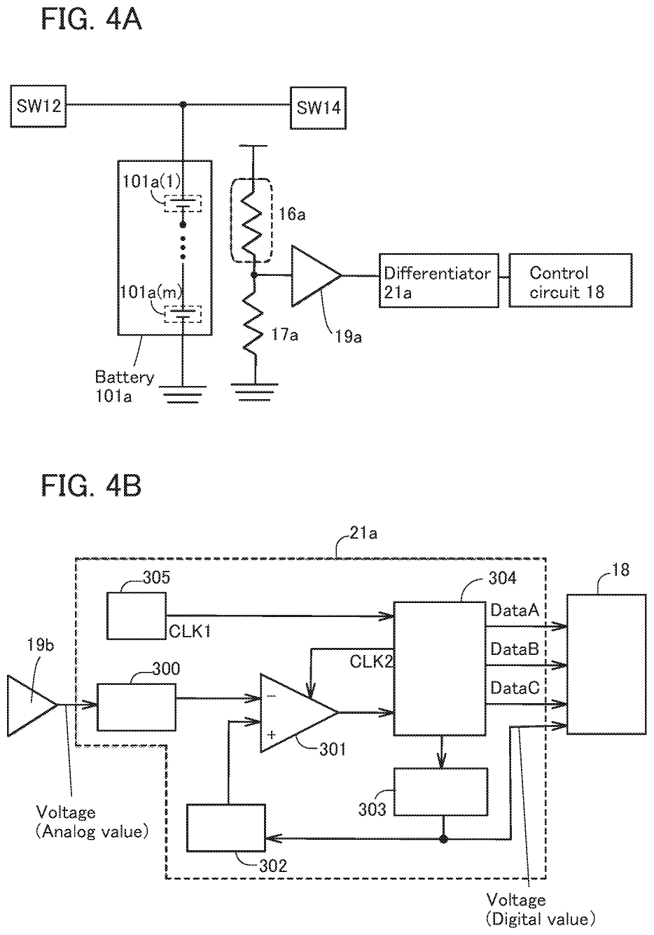

FIG. 4A illustrates an example in which a differentiator 21a is provided instead of the A/D circuit 20a in the structure regarding the temperature sensor 102 including the battery 101a, the thermistor 16a, and the like. Although a differentiator 21b can be provided instead of an A/D circuit 20b also in the structure regarding the temperature sensor 102 including the battery 101b, the thermistor 16b, and the like, the differentiator 21b is not illustrated in FIG. 4A.

FIG. 4B illustrates details of the differentiator 21a and the control circuit 18. The differentiator 21a includes a sample-and-hold circuit 300, a comparator 301, a DA converter 302, a successive approximation register 303, a second control circuit 304, a clock generation circuit 305, and the like.

In the differentiator 21a illustrated in FIG. 4B, a voltage (analog value) output from the buffer amplifier 19a can be retained in the sample-and-hold circuit 300. While the analog value is converted into a digital value by the comparator 301 and the successive approximation register 303, the sample-and-hold circuit 300 preferably retains the analog value. As a transistor included in the sample-and-hold circuit 300, an OS transistor can be used. An OS transistor is a transistor in which an oxide semiconductor layer is used as an active layer.

For example, the off-state current value per micrometer of a channel width of an OS transistor at room temperature can be lower than or equal to 1 aA (1×10⁻¹⁸ A), lower than or equal to 1 zA (1×10⁻²¹ A), or lower than or equal to 1 yA (1×10⁻²⁴ A). Note that the off-state current value per micrometer of channel width of a Si transistor at room temperature is higher than or equal to 1 fA (1×10⁻¹⁵ A) and lower than or equal to 1 pA (1×10⁻¹² A). In other words, the off-state current of an OS transistor is lower than the off-state current of a Si transistor by approximately ten orders of magnitude. Such a transistor with a low off-state current is suitable for the sample-and-hold circuit 300.

A value output from the sample-and-hold circuit 300 is input to the comparator 301, goes through the second control circuit 304, and is compared with data of the successive approximation register 303. The successive approximation register 303 outputs digital data, which is obtained by dividing an analog value of voltage into at least two or more digital values and allocating each digital value to each bit. The digital data is converted from digital data into analog data through the DA converter 302 before being input to the comparator 301. Then, in the comparator 301, the data from the sample-and-hold circuit 300 and the data from the successive approximation register 303 are compared. In the case where the two pieces of data match, 0 is output from the comparator 301, and in the case where the two pieces of data do not match, 1 is output from the comparator 301. The value 0 or 1 is output to the second control circuit 304, and the data which has been determined to match is output as a digital value from the successive approximation register 303 to the control circuit 18. In this manner, the voltage converted into a digital value can be detected.

Furthermore, Data DataA, data DataB, and data DataC may be output from the second control circuit 304 to the control circuit 18. A sign (e.g., +) representing a temperature decrease or a sign (e.g., −) representing a temperature decrease can be assigned to the Data DataA, for example. The data DataB is data regarding time, for example. For example, time is counted on the basis of a clock signal (CKL1) or the like input to the differentiator 21a, so that the above-described data on time can be output. The data DataC is an error flag. For example, in the case where the relation between the temperature and voltage of the graph in FIG. 3B is satisfied, there seems to be a relation of an approximately 5° C. change by approximately 50 mV. With reference to the time of the 5° C. change by 50 mV and using the above-described data regarding time, error data can be assigned. In the second control circuit 304, a change exceeding the reference is determined as an error and can be flagged.

The temperature of the battery 101a can be obtained using a temperature sensor or the like including a differentiator as illustrated in FIG. 4A and FIG. 4B. Similarly, the temperature of the battery 101b can be obtained. Furthermore, the average temperature of the battery 101a and the battery 101b can also be obtained.

As illustrated in FIG. 4A and FIG. 4B, a differentiator is preferably provided in a temperature sensor or the like in order to enable error processing.

### Specific Example of Circuit 103

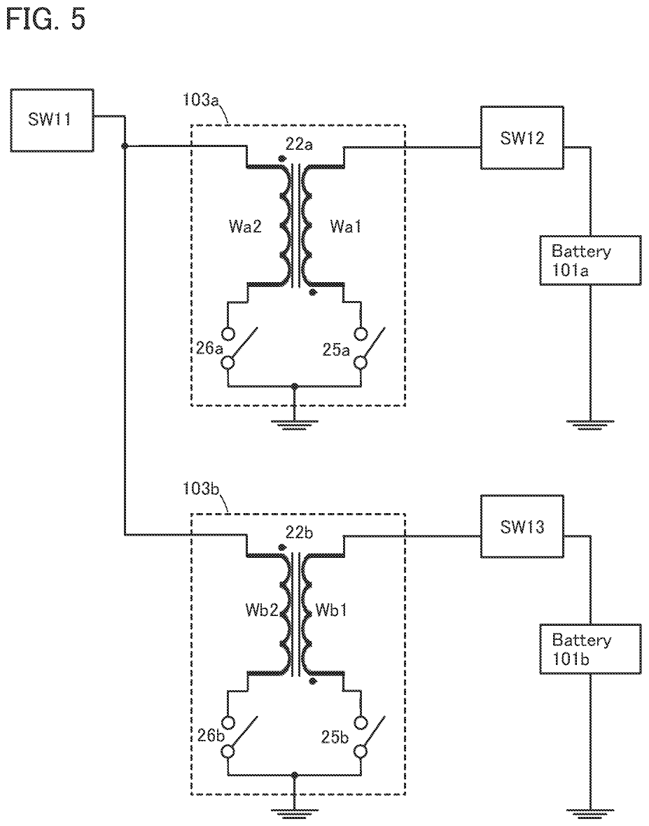

Next, a circuit structure and the like of the circuit 103a and the circuit 103b are described with reference to FIG. 5. Since the circuit 103b has a circuit structure similar to that of the circuit 103a, the description of the circuit 103b is sometimes simplified.

The circuit 103a includes a transformer 22a, and an isolation transformer is used as the transformer 22a, for example. In some cases, a coil Wa1 on one side included in the transformer 22a is referred to as a primary circuit of the transformer 22a and a coil Wa2 on the other side included in the transformer 22a is referred to as a secondary circuit of the transformer 22a. In the primary circuit, one side of the coil Wa1 is electrically connected to the SW12, and the other side is electrically connected to a SW25a. The SW12 is electrically connected to the battery 101a.

As in the primary circuit, the secondary circuit of the transformer 22a includes the coil Wa2 and a SW26a. One side of the coil Wa2 is electrically connected to the SW11, and the other is electrically connected to the SW26a.

When a current is supplied to one coil of the transformer 22a, for example, to the coil Wa1, a magnetic field generated from the coil causes generation of induced electromotive force in the other coil, for example, the coil Wa2. This phenomenon is referred to as mutual induction in some cases. This induces a voltage to the other coil, for example, the coil Wa2, so that a current flows through the coil Wa2. Although the winding number of the coil Wa1 is the same as the winding number of the coil Wa2 in this embodiment, their winding numbers may be different from each other.

As the SW25a and the SW26a in the circuit 103a, switching elements such as MOS transistors are preferably used. For rectification, a resistor may be electrically connected to the SW25a. Similarly, a resistor may be electrically connected to the SW26a. By turning on and off the SW25a and the SW26a, the timing of current flow owing to the above-described induced electromotive force can be controlled.

The circuit 103b has a structure similar to that of the above-described circuit 103a. In the circuit 103b, one side of a coil Wb1 is electrically connected to the SW13. The SW13 is electrically connected to the battery 101b.

### In Charging

A case where the battery 101a is charged is described. The circuit 103a including the transformer 22a and the circuit 103b including a transformer 22b are each used as a flyback converter or a forward converter.

First, a case of a flyback converter is described. When the SW26a is turned on and a current flows through the coil Wa2, an iron wire (also referred to as a core) included in the circuit 103a is magnetized by the generated magnetic flux. The magnetization of the core is referred to as energy accumulation in some cases. When the SW25a is off, the voltage of the coil Wa2 is decreased and a current does not flow through the coil Wa1. After that, when the SW26a is turned off, energy accumulated in the core is released, so that a current flows through the coil Wa1.

If the SW12 is on, the current flowing through the coil Wa1 can be supplied to the battery 101a and charging is possible.

The same as the above-described case of charging the battery 101a applies to a case of charging the battery 101b.

Next, a case of a forward converter is described. When the SW26a is turned on, induced electromotive force is generated in the coil Wa1 and the coil Wa2. The induced electromotive force is referred to as electromotive force in some cases. A current flows through the coil Wa1 and the coil Wa2 in accordance with the induced electromotive force. The direction of current is controlled by a diode, and energy is accumulated in a choking coil, for example. After that, when the SW26a is turned off, energy accumulated in the choking coil is released, so that a current flows in a direction controlled by the diode.

If the SW12 is on, the current flowing through the choking coil can be supplied to the battery 101a and charging is possible.

That is, the circuit 103a includes the diode and the choking coil.

The same as the above-described case of charging the battery 101a applies to a case of charging the battery 101b.

### In Transferring

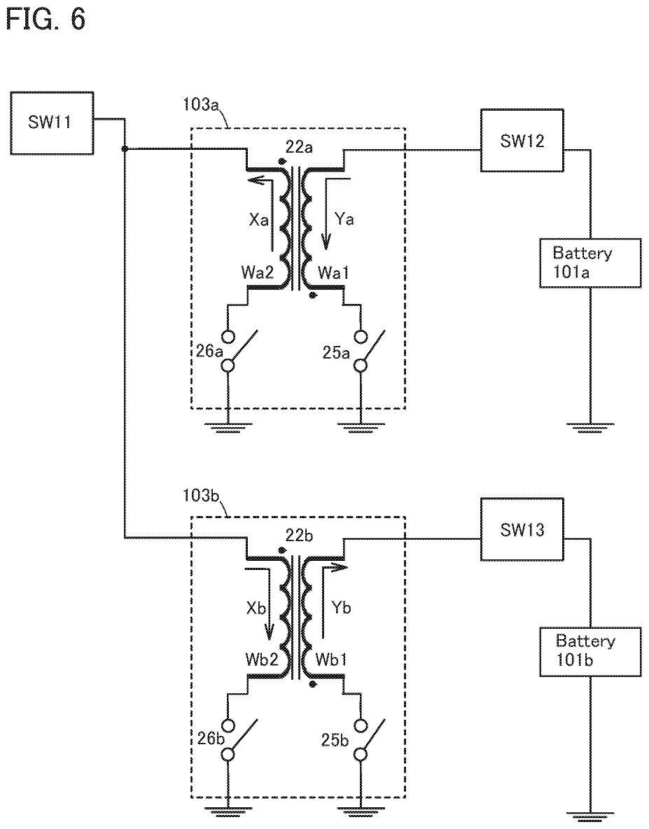

Next, a case of transferring power of one of the battery 101a and the battery 101b to the other is described with reference to FIG. 6. FIG. 6 additionally illustrates arrows indicating directions of current flow (Xa, Ya, Xb, and Yb) on the circuit structure illustrated in FIG. 5.

The case where the power of the battery 101a is transferred to the battery 101b is described. First, the SW25a and the SW12 are turned on to extract a current that is transferred from the battery 101a. In FIG. 6, the current flowing from the battery 101a through the coil Wa1 of the transformer 22a is indicated by the arrow Ya. The current flowing as indicated by the arrow Ya is referred to as I (discharge) in some cases. The current that is transferred from the battery 101a can be determined in accordance with the temperature. The current that is transferred can also be determined in accordance with the SOC of the battery 101a. Note that the SOC is a state of charge (State of Charge rate) of the above-described battery cell.

When the SW25a is turned off and the SW26a is turned on, a current corresponding to the I (discharge) is generated in the coil Wa2. In FIG. 6, the current flowing through the coil Wa2 of the transformer 22a is indicated by the arrow Xa. The current flowing as indicated by the arrow Xa is referred to I (return) or return of charge in some cases.

Since the SW26b is on, a current corresponding to I (return) flows through a coil Wb2 of the transformer 22b of the circuit 103b. In FIG. 6, the current flowing through the coil Wb2 is indicated by the arrow Xb. The current flowing as indicated by the arrow Xb is referred to I (supply) or supply of charge in some cases. The value of the current indicated by the arrow Xb is equal to that of the current indicated by the arrow Xa.

Then, the SW26b is turned off and the SW25b is turned on, so that a current corresponding to the I (supply) flows through the coil Wb1 of the transformer 22b. In FIG. 6, the current flowing through the coil Wb2 is indicated by the arrow Yb. The current flowing as indicated by the arrow Yb is referred to as I (charge) in some cases.

When the SW13 is on, the I (charge) is used to charge the battery 101b. In this manner, power is transferred from the battery 101a to the battery 101b.

Although the case where the power of the battery 101a is transferred to the battery 101b has been described, power of the battery 101b can be transferred to the battery 101a as well, in which case the current flow direction and the like are opposite to those of the above description.

### Specific Examples of DCDC Circuit

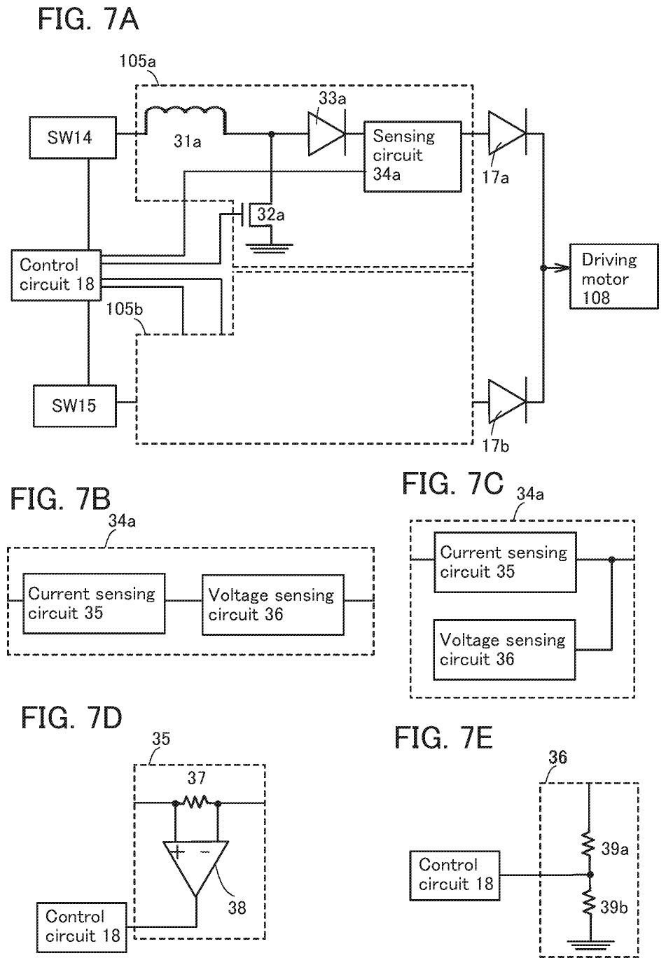

Next, structure examples of the DCDC circuit will be described with reference to FIG. 7A to FIG. 7E.

FIG. 7A illustrates the SW14 controlled by the control circuit 18 and the DCDC circuit 105a electrically connected to the SW14. An output from the battery 101a (not illustrated in FIG. 7A) is supplied to the DCDC circuit 105a through the SW14. The DCDC circuit 105a includes a coil 31a. By the coil 31a, an output, specifically, an output voltage, from the battery 101a can be amplified.

The DCDC circuit 105a includes a switch electrically connected to the coil 31a, specifically a transistor 32a, and the transistor 32a is controlled by the control circuit 18. By repeating turning on and off the transistor 32a electrically connected to the coil 31a, the output voltage can be amplified.

The DCDC circuit 105a preferably includes a diode 33a electrically connected to the coil 31a. The diode 33a is preferably provided to rectify a signal.

Furthermore, the DCDC circuit 105a includes a sensing circuit 34a that is positioned on the output side of the diode 33a. The sensing circuit 34a can output voltage data or current data of the sensing circuit 34a to the control circuit 18, and the control circuit 18 controls on/off of the transistor 32a on the basis of the data so that the amplified output voltage can be within an appropriate range. Then, the output voltage amplified within the appropriate range is output to the diode 17a and is supplied to a driving motor 108 through the diode 17a.

Since the DCDC circuit 105b has a structure similar to that of the DCDC circuit 105a, the description of the DCDC circuit 105b is omitted. Also in the DCDC circuit 105b, an output voltage amplified within an appropriate range is output to the diode 17b and supplied to the driving motor 108 through the diode 17b. The voltage in the appropriate range is a voltage appropriate for rotating the driving motor 108 and, in many cases, higher than the voltage obtained from the battery 101a and the battery 101b.

FIG. 7B and FIG. 7C illustrate connection examples of the sensing circuit 34a. As illustrated in FIG. 7B, the sensing circuit 34a can include a current sensing circuit 35 and a voltage sensing circuit 36 serially connected to the current sensing circuit 35. As illustrated in FIG. 7C, the sensing circuit 34a can include a circuit in which the current sensing circuit 35 and the voltage sensing circuit 36 are connected in parallel.

FIG. 7D illustrates a specific example of the current sensing circuit 35. As the current sensing circuit 35, a resistor 37 and an operational amplifier 38 electrically connected to both ends of the resistor 37 are preferably included. The output value of the operational amplifier 38 is voltage data, and the data is output to the control circuit 18. For example, when the voltage data is too high, the transistor 32a is controlled so that the voltage is decreased, and when the voltage data is too low, the transistor 32a is controlled so that the voltage is increased. Depending on the current sensing circuit 35, the current data can be output to the control circuit 18.

FIG. 7E illustrates a specific example of the voltage sensing circuit 36. As the voltage sensing circuit 36, a resistor 39a and a resistor 39b are preferably included. The voltage data obtained by resistance division is output to the control circuit 18. For example, when the voltage data is too high, the transistor 32a is controlled so that the voltage is decreased, and when the voltage data is too low, the transistor 32a is controlled so that the voltage is increased. Depending on the voltage sensing circuit 36, the current data can be output to the control circuit 18.

With the battery control system of one embodiment of the present invention, the output from each of the batteries can be controlled in accordance with the temperature. With the battery control system of one embodiment of the present invention, energy transmission and reception, that is, energy transfer between the batteries in accordance with the temperature is possible.

With one embodiment of the present invention, each of the batteries can be efficiently used and an imbalance in a deterioration state can be inhibited. Furthermore, with one embodiment of the present invention, power can be stably supplied.

This embodiment can be used in appropriate combination with the other embodiments.

### Embodiment 2

In this embodiment, a new structure included in the battery control system of one embodiment of the present invention will be described.

In the case where the battery 101a and the battery 101b include assembled batteries, variation in the state of the battery cell might occur. The states of the battery cells in the battery 101a and the battery 101b having different battery characteristics vary differently. Thus, an example in which the battery control system 10 that is one embodiment of the present invention includes the BMU 112 provided with the balancing circuit 104a and the balancing circuit 104b in order to control the states of the battery cells is described.

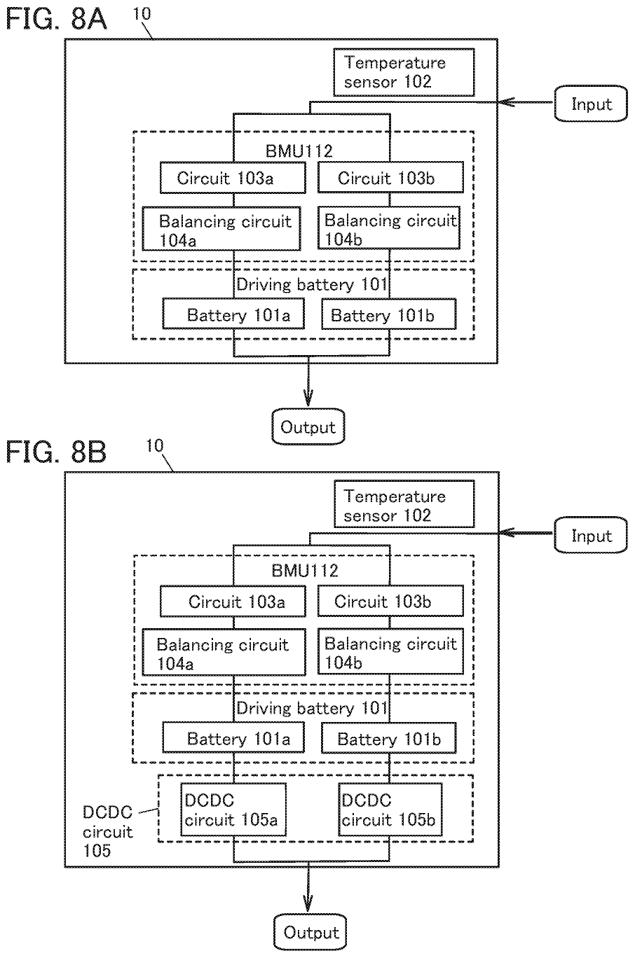

Unlike in FIG. 1A, the battery control system 10 illustrated in FIG. 8A includes the balancing circuit 104a and the balancing circuit 104b provided in the BMU 112. Unlike in FIG. 1B, the battery control system 10 illustrated in FIG. 8B includes the balancing circuit 104a and the balancing circuit 104b provided in the BMU 112.

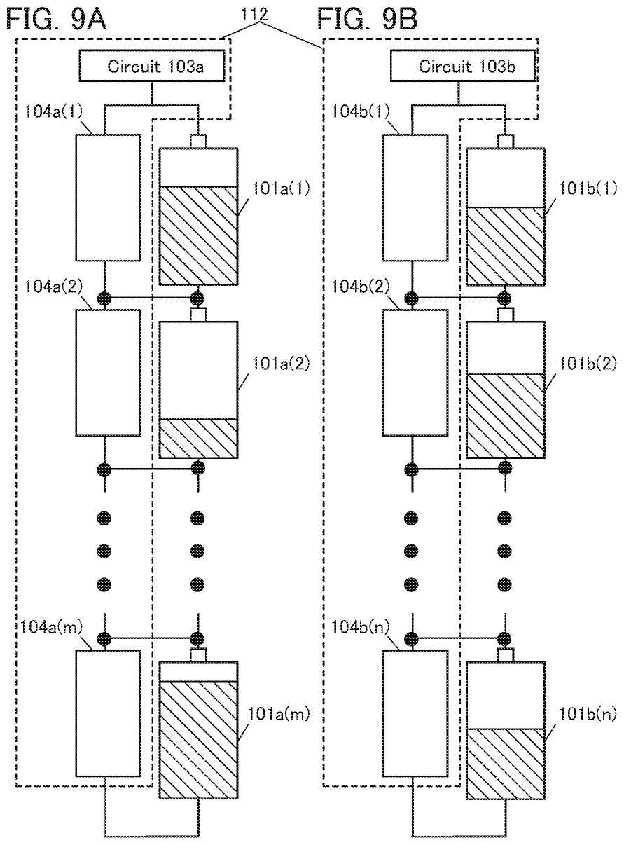

FIG. 9A illustrates a case in which the state of the battery cell, specifically, the SOC varies in the battery 101a including an assembled battery (among a battery 101a(1), a battery 101a(2), and a battery 101a(m)). Different SOCs are represented by the area of the shaded region. When the deterioration rate of the battery 101a(1) and the deterioration rate of the battery 101a(2) differ from each other, a difference in the SOC arises between the battery 101a(1) and the battery 101a(2).

FIG. 9A also illustrates the balancing circuit 104a (a balancing circuit 104a(1), a balancing circuit 104a(2), and a balancing circuit 104a(m)) included in the BMU 112. The balancing circuit 104a(1) is electrically connected to the battery 101a(1), so that the present state, specifically, the SOC, of the battery 101a(1) can be grasped. Similarly, since the balancing circuit 104a(2) and the balancing circuits 104a thereafter are respectively also electrically connected to the battery 101a(2) and the batteries 101a thereafter, the present SOCs of the batteries 101a can be grasped by the balancing circuits 104a.

FIG. 9B illustrates a relation between the battery 101b including an assembled battery (a battery 101b(1), a battery 101b(2), and a battery 101b(n)) and the balancing circuit 104b (a balancing circuit 104b(1), a balancing circuit 104b(2), and a balancing circuit 104b(n)). As in FIG. 9A, the present SOC of the battery 101b can be grasped by the balancing circuit 104b.

Furthermore, after the above-described SOCs are grasped, the SOCs of the battery cells are preferably homogenized (referred to as cell balancing process). For example, before charging of the driving battery 101, the cell balancing process is preferably executed on the battery 101a. Furthermore, before charging of the driving battery 101, the cell balancing process is preferably executed on the battery 101b.

Moreover, before charging of the driving battery 101, the cell balancing process is preferably executed on the battery 101a and the battery 101b. Although the SOC of the battery 101b is preferably made equal to the SOC of the battery 101a by the cell balancing process, the SOCs of the battery 101a and the battery 101b may be different.

In the description of FIG. 9A and FIG. 9B, m is used as the number of battery cells in the battery 101a and n is used as the number of battery cells in the battery 101b; m and n above each represent a natural number of 1 or more. Furthermore, m representing the number of battery cells may be equal to n (m=n). Furthermore, m representing the number of battery cells may be larger than n (m>n). Furthermore, m representing the number of battery cells may be smaller than n (m<n).

Although the sizes of the battery 101a and the battery 101b illustrated in FIG. 9A and FIG. 9B are the same, the size of the battery 101a may be different from the size of the battery 101b. For example, the size of the battery 101a may be larger than the size of the battery 101b.

The battery 101a may be a laminated battery cell described later, and the battery 101b may be a rectangular battery cell or a cylindrical battery cell described later.

Alternatively, the battery 101a may be a rectangular battery cell described later, and the battery 101b may be a laminated battery cell or a cylindrical battery cell described later.

Alternatively, the battery 101a may be a cylindrical battery cell described later, and the battery 101b may be a laminated battery cell or a rectangular battery cell described later.

In view of the size or configuration of the above-described batteries, it is preferable that the SOC of the battery 101b is preferably made equal to the SOC of the battery 101a by the cell balancing process; however, the SOCs of the battery 101a and the battery 101b may be different.

Thus, since the state of each battery can be grasped in the battery control system 10 of one embodiment of the present invention, each battery can be used in an appropriate state in accordance with the temperature.

### Balancing Circuit

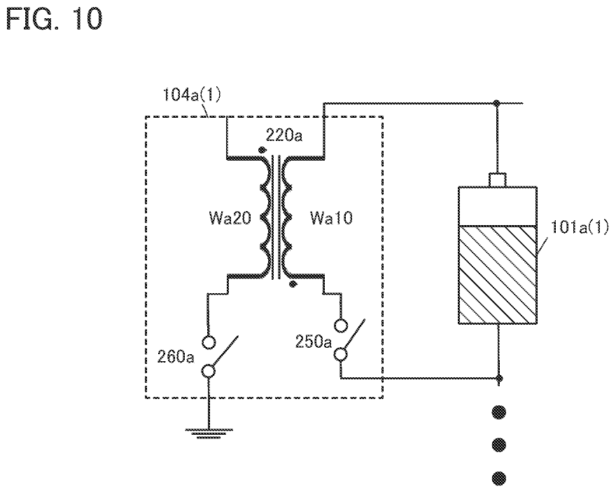

FIG. 10 illustrates a specific example of the balancing circuit 104a, typically the balancing circuit 104a(1) in FIG. 9A.

The balancing circuit 104a(1) includes a transformer 220a and includes a switch 250a and a SW260a that control the transformer 220a. The transformer 220a includes coils Wa10 and Wa20. In the case where it is determined on the basis of the SOC of the battery 101a(1) that charging should be performed, a current is supplied to the battery 101a(1) through the coil Wa10. In the case where it is determined on the basis of the SOC of the battery 101a(1) that discharging should be performed, a current is released from the battery 101a(1) through the coil Wa20.

Since the same structure as that of the above-described balancing circuit 104a(1) can be employed even after the balancing circuit 104a(2), the description of the balancing circuit 104a(2) and the balancing circuits 104a thereafter is omitted.

Since the balancing circuit 104b has a structure similar to that of the balancing circuit 104a, the description of the balancing circuit 104b is omitted.

Thus, the cell balancing process of each battery can be executed in the battery control system 10 of one embodiment of the present invention, which enables an assembled battery to be charged efficiently in accordance with the temperature.

The BMU 112 or the like can execute a battery remaining capacity estimation process on the basis of the grasped SOC. For example, the estimation of the SOC-OCV characteristics, the estimation of FCC, or the estimation of the internal resistance of each battery cell is executed, so that the battery remaining capacity estimation process is possible. OCV refers to an open circuit voltage. FCC refers to full charge capacity. The internal resistance can be estimated from a voltage and a current between the positive electrode terminal and the negative electrode terminal of the battery cell.

In this manner, in the battery control system 10 of one embodiment of the present invention, the output of power from each battery can be controlled in accordance with the temperature, and each battery can be used in an appropriate state in accordance with the temperature.

### Embodiment 3

In this embodiment, an electric vehicle (EV) provided with the battery control system of one embodiment of the present invention is described.

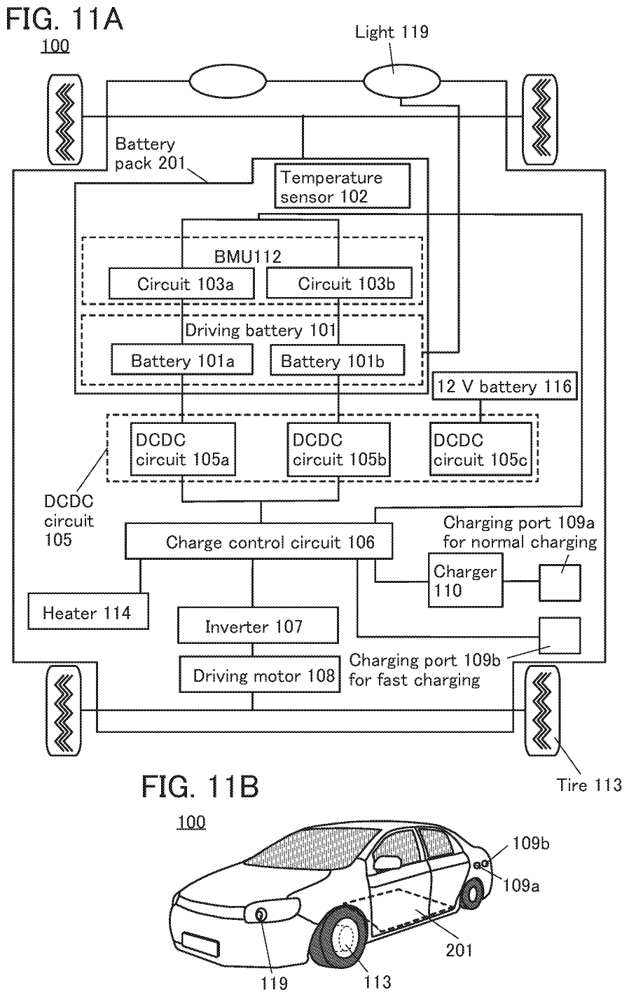

As illustrated in FIG. 11A, an electric vehicle 100 of this embodiment includes the driving battery 101, the temperature sensor 102, the BMU 112, the DCDC circuit 105, a charge control circuit 106, an inverter 107, the driving motor 108, a charging port 109a for normal charging, a charging port 109b for fast charging, a charger 110, a tire 113, a heater 114, a 12 V battery 116, a light 119, and the like. The heater 114 includes a unit that controls air conditioning in the vehicle, a unit that controls the temperature of the driving battery 101, and the like.

The electric vehicle 100 in FIG. 11A includes the battery control system 10 illustrated in FIG. 1B in the above embodiment. The electric vehicle 100 can at least transfer power between the battery 101a and the battery 101b as in <Structure example 1 of battery control system>. Furthermore, in the electric vehicle 100, the output from the battery 101a and the output from the battery 101b can be different from each other as in <Structure example 2 of battery control system>. Furthermore, the electric vehicle 100 can perform control as in <Structure example 3 of battery control system>.

Alternatively, the electric vehicle 100 in FIG. 11A can include the battery control system 10 illustrated in FIG. 1A in the above embodiment. Alternatively, the electric vehicle 100 in FIG. 11A can include the battery control system 10 illustrated in FIG. 8A and FIG. 8B in the above embodiment.

The output voltage from the driving battery 101 included in the electric vehicle 100 is preferably higher than or equal to 300 V and lower than or equal to 900 V, further preferably higher than or equal to 350 V and lower than or equal to 800 V. In this embodiment, the total voltage of the battery 101a and the voltage of the battery 101b is higher than or equal to 3300 V and lower than or equal to 900 V, preferably higher than or equal to 350 V and lower than or equal to 800 V.

The output voltage can be determined in accordance with the number of battery cells included in the battery 101a and the battery 101b. For example, the battery 101a can include three assembled batteries each including a hundred battery cells. Serial connection is made between the hundred battery cells, and parallel connection is made between the three assembled batteries. The battery 101b can similarly include a plurality of assembled batteries each including a plurality of battery cells. With such a structure, the output voltage from the driving battery 101 can be increased.

Furthermore, the output voltage can also be increased using the DCDC circuit 105. For example, even when the output voltage from the driving battery 101 is lower than 600 V, the voltage can be increased to be higher than or equal to 600 V and lower than or equal to 900 V, preferably higher than or equal to 650 V and lower than or equal to 850 V by the DCDC circuit 105. The increased voltage is output to the driving motor 108.

The charging port 109a for normal charging, the charging port 109b for fast charging, or the like in FIG. 11A can correspond to the input of the above-described battery control system in FIG. 1B, and the driving motor 108 in FIG. 11A can correspond to the output of the battery control system.

Next, a battery pack 201 is described. The battery pack 201 is a battery unit that can be mounted on the electric vehicle 100. The battery pack 201 of this embodiment illustrated in FIG. 11A includes the driving battery 101, the temperature sensor 102, the BMU 112, and the like. Although the battery pack 201 also includes a cooling device and the like in addition to the above, they are not illustrated in FIG. 11A. As the cooling device, a cooling device of a water-cool type, an air-cool type, or the like can be used. The battery pack 201 includes a housing made of iron or the like, and the housing or the like is designed so as to be highly sealed for prevention of electrical defects due to flooding. In view of the structure of the battery pack 201, the battery control system of the above embodiment illustrated in FIG. 1A can be regarded as a battery control system included in the battery pack 201 in FIG. 11A.

Note that without forming a unit of the battery pack 201, the driving battery 101, the temperature sensor 102, the BMU 103, and the like may be directly mounted on the electric vehicle 100.

FIG. 11B illustrates the appearance of the electric vehicle 100 of this embodiment. FIG. 11B illustrates a state where the battery pack 201 is stored underneath the vehicle and also illustrates the tire 113, the light 119, the charging port 109a for normal charging, the charging port 109b for fast charging, and the like as the parts that can be recognized by its appearance. It is preferable that the light 119 be supplied with power from the driving battery 101.

### Charging Port, In-Vehicle Charger (Charger), Charging Apparatus (Charging Point)

As illustrated in FIG. 11A, the electric vehicle 100 that is one embodiment of the present invention includes the charging port 109a for normal charging. The charging port 109a for normal charging is electrically connected to a charging point and the driving battery 101 can be charged from the charging point. The charging port 109a for normal charging is electrically connected to the charger 110, and the charger 110 includes a converter such as an ACDC circuit. With the ACDC circuit or the like, an alternating current from the charging point can be converted into a direct current. That is, in normal charging, a process of converting an alternating current into a direct current is performed on the electric vehicle 100 side. Therefore, in normal charging, it takes time to perform charging in some cases.

As illustrated in FIG. 11A, the charger 110 is electrically connected to the charge control circuit 106, and power is supplied from the charge control circuit 106 to the driving battery 101. The charge control circuit 106 will be described later.

As illustrated in FIG. 11A, the electric vehicle 100 that is one embodiment of the present invention includes the charging port 109b for fast charging, and the electric vehicle 100 can also be charged via the charging port 109b for fast charging. In fast charging, the process of converting an alternating current into a direct current is performed on the charging point. The charging point can be provided with a large-scale circuit for the process, so that the process can be executed at high speed and thus the charging time can be shortened in fast charging.

Since the battery voltage required for the electric vehicle 100 is high as described above, the number of battery cells included in the driving battery 101 tends to increase. If the normal charging is performed on the assembled battery including many battery cells, considerable charging time is required in some cases. Therefore, fast charging is more suitable than normal charging for charging of the electric vehicle 100 with a high battery voltage.

In this embodiment, one of the battery 101a and the battery 101b may be configured to be capable of fast charging and the other may be configured to be capable of normal charging. For example, the battery 101a being the battery for normal-temperature use is capable of fast charging; and normal charging is more suitable than fast charging for the battery 101b being the battery for low-temperature use.

The charging port 109b for fast charging is electrically connected to the charge control circuit 106 not through the charger 110, and power is supplied from the charge control circuit 106 to the driving battery 101. The charge control circuit 106 will be described later.

The charging point may be a power source in a house or a charging station provided in a commerce facility. The charging point capable of fast charging is often provided in the above-described charging station.

Furthermore, a given method such as CHAdeMO (registered trademark) or Combined Charging System can be used as a charge method, the standard of a connector, and the like.

### Charge Control Circuit, Inverter, Driving Motor

The electric vehicle 100 that is one embodiment of the present invention includes the charge control circuit 106. The charge control circuit 106 preferably includes a current sensor, a relay circuit, a fuse, and the like. As the above-described relay circuit, the charge control circuit 106 preferably includes a relay circuit for fast charging, a relay circuit for normal charging, and a main relay circuit. Each of the above-described relay circuits is electrically connected to the current sensor, and when it is determined by the current sensor or the like that the current exceeds a predetermined current value, fast charging or normal charging can be forced to end. The electric vehicle 100 can be charged safely with the charge control circuit 106. Although the charge control circuit 106 is separated from the battery pack 201 in the illustration in FIG. 11A, the charge control circuit 106 may be provided for the battery pack 201.

The charge control circuit 106 can control a high-voltage system with an output voltage of the driving battery 101 of, for example, higher than or equal to 300 V and lower than or equal to 850 V, preferably higher than or equal to 400 V and lower than or equal to 800 V. The charge control circuit 106 can also control an electronic component in the high-voltage (12 V or higher voltage, e.g., 42 V or 48V) system. For example, the charge control circuit 106 controls an in-vehicle component (e.g., the heater 114 or an electric power steering) in the 42 V system.

To the charge control circuit 106, power of the driving battery 101 is supplied through the DCDC circuit 105. The power is adjusted to an appropriate voltage or the like by the DCDC circuit 105 so that power can be supplied to the driving motor 108. That is, in the case where the voltage output from the driving battery 101 is high voltage, the high voltage is converted into a low voltage by the DCDC circuit 105. Then, power is transferred to the inverter 107, where a direct current is converted into an alternating current. That is, the inverter 107 is one of the converters.

The driving motor 108 can rotate the tire 113 by receiving appropriate power from the inverter 107.

### 12 V Battery

As illustrated in FIG. 11A, the electric vehicle 100 that is one embodiment of the present invention includes a 12 V battery 116. A lead battery can be used as the 12 V battery 116. The 12 V battery 116 is used at the time of activating the electric vehicle 100. Furthermore, the 12 V battery 116 can supply power to an in-vehicle component (blinkers or an audio system) and the like in the 12 V system. Such a 12V battery is referred to as an auxiliary battery in some cases.

The output from the 12 V battery 116 is preferably supplied to a DCDC circuit 105c. That is, the DCDC circuit 105 preferably includes the DCDC circuit 105a to the DCDC circuit 105c.

An electric vehicle provided with a battery control system of one embodiment of the present invention can control energy output from each battery in accordance with the temperature. An electric vehicle provided with a battery control system of one embodiment of the present invention can perform energy transmission and reception, that is, energy transfer between batteries in accordance with the temperature.

With one embodiment of the present invention, each battery of an electric vehicle can be efficiently used and an imbalance in a deterioration state can be inhibited. Furthermore, with one embodiment of the present invention, power can be stably supplied to an electric vehicle.

### Usage Example 1

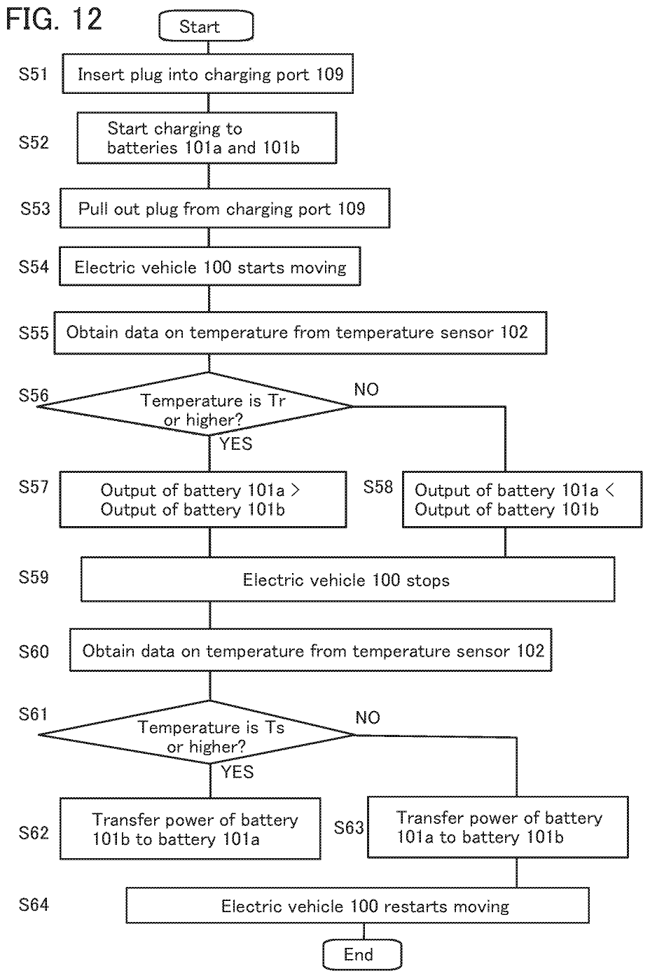

Next, a usage example 1 of the battery control system or the like of one embodiment of the present invention is described with reference to FIG. 12.

In Step S51, a plug of a charging point is inserted into the charging port 109. In Step S52, charging to the battery 101a and the battery 101b starts. In Step S53, the plug is pulled out from the charging port 109. In Step S54, the electric vehicle 100 starts moving.

In Step S55, data on the temperature is obtained from the temperature sensor 102. In Step S56, whether the temperature is Tr or higher is determined. Tr is within the first temperature range of the battery 101a and can be determined by the specifications. For example, Tr can be the temperature of the time when the output of the battery 101a becomes 80% or lower of the maximum output. For example, in the case where the temperature is 0° C., whether the temperature is 0° C. or higher is determined in Step S55.

In the case where the temperature is Tr or higher (in the case of YES), the output of the battery 101a is controlled to be higher than the output of the battery 101b in Step S56. In Step S56, the output of the battery 101b may be stopped. For example, in the case where the temperature is 25° C., the output of the battery 101b can be stopped and only the output of the battery 101a can be supplied to the driving motor. When the temperature is higher than or equal to 25° C. and the battery 101b does not operate or significantly deteriorates, only the battery 101a is preferably used as the driving battery 101.

In the case where the temperature is lower than Tr (in the case of NO), the output of the battery 101b is controlled to be higher than the output of the battery 101a in Step S58. In Step S58, the output of the battery 101a may be stopped. For example, in the case where the temperature is −20° C., the output of the battery 101a can be stopped and only the output of the battery 101b can be supplied to the driving motor. When the temperature is lower than or equal to −20° C. and the battery 101a does not operate or significantly deteriorates, only the battery 101b is preferably used as the driving battery 101.

By appropriately operating the battery 101a and the battery 101b in accordance with the temperature in this manner, deterioration of each battery can be inhibited while appropriate power is supplied to the driving motor 108.

Next, the electric vehicle 100 stops in Step S59. Stopping of the vehicle means a temporary stop and is different from parking. In this state, data on the temperature is obtained from the temperature sensor 102 in Step S60, and whether the temperature is Tr or higher is determined in Step S61. Although the temperature Tr as the reference for the determination in Step S61 is equal to the temperature Tr as the reference for the determination in Step S55 in the description, the temperature Tr as the reference for the determination in Step S61 may be higher than the temperature Tr as the reference for the determination in Step S55. The temperature Tr as the reference for the determination in Step S61 may be lower than the temperature Tr as the reference for the determination in Step S55.

In the case where the temperature is Tr or higher (in the case of YES), power of the battery 101b is transferred to the battery 101a in Step S62, which is based on the premise that power is remaining in the battery 101b. For example, in the case of the temperature Tr=25° C., if the driving motor 108 can be operated only by the battery 101a, power can be transferred to the battery 101a until the power of the battery 101b becomes zero or close to zero.

In the case where the temperature is lower than Tr (in the case of NO), power of the battery 101a is transferred to the battery 101b in Step S63, which is based on the premise that power is remaining in the battery 101a. For example, in the case where the temperature is −20° C., if the driving motor 108 can be operated only by the battery 101b, power can be transferred to the battery 101b until the power of the battery 101a becomes zero or close to zero.

After the transfer of power, the electric vehicle 100 starts moving in Step S64. Thus, power of the battery 101a and the battery 101b can be set in an appropriate state in accordance with the temperature, and deterioration of each battery can be inhibited.

Thus, with one embodiment of the present invention, the output of one of two or more kinds of batteries can be set higher than the output of the other, power of one of the batteries can be transferred to the other in accordance with the temperature by utilizing a period when the vehicle stops, and the SOC of each battery can be set in an appropriate state in accordance with the temperature. For example, one of the above-described batteries is a battery for normal-temperature use, and a battery for low-temperature use can be used as the other battery. Note that the one and the other described above are examples and can be replaced in accordance with the temperature.

### Usage Example 2

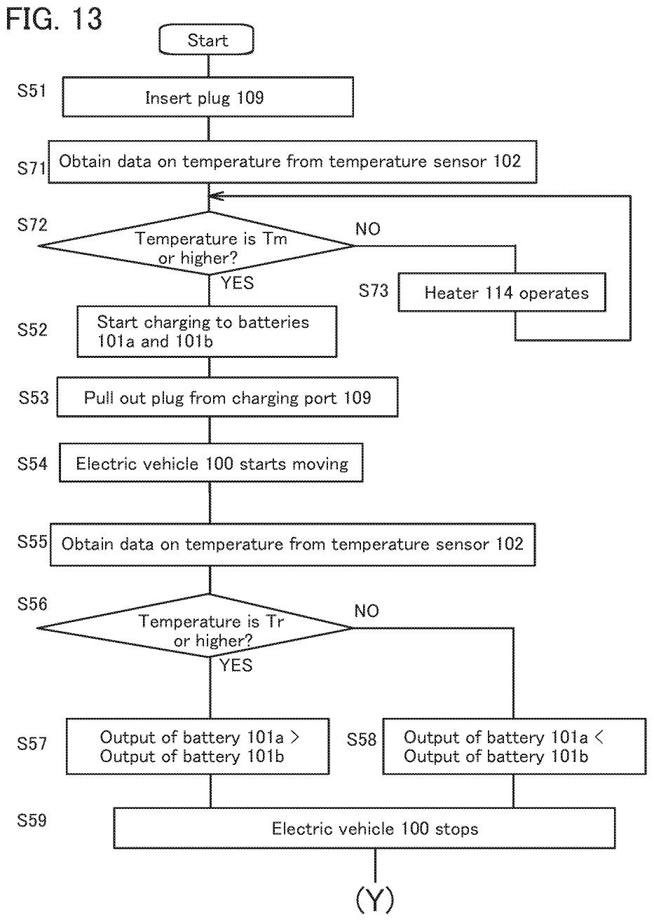

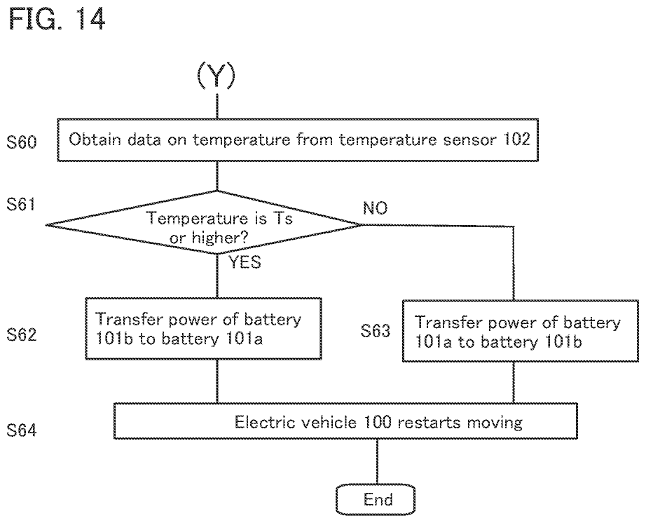

Next, a usage example 2 of the battery control system or the like of one embodiment of the present invention is described with reference to FIG. 13 and FIG. 14.

First, in a manner similar to that of the usage example 1, a plug of a charging point is inserted into the charging port 109 in Step S51. Then, unlike in the usage example 1, data on the temperature is obtained from the temperature sensor 102 in Step S71, and whether the temperature is Tm or higher is determined in Step S72. Tm can be determined by the battery characteristics of the battery 101a and the battery 101b, and in the case of Tm=−10° C., whether the temperature is −10° C. or higher is determined in Step S72, for example.

In a manner similar to that of the usage example 1, in the case where the temperature is Tm or higher (in the case of YES), charging to the battery 101a and the battery 101b starts in Step S52. In Step S53, the plug is pulled out from the charging port 109. In Step S54, the electric vehicle 100 starts moving.

In the case where the temperature is lower than Tm (in the case of NO), the heater 114 is made to operate in a manner different from that of the usage example 1. Then, the process returns to Step S72, and whether the temperature is Tm or higher is determined. In other words, in the usage example 2, the temperature at the time of charging the battery 101a and the battery 101b is controlled to be Tm or higher.

Subsequent Step S54 to Step S59 are similar to those in the usage example 1. The process proceeds from (Y) of FIG. 13 to (Y) of FIG. 14, and subsequent Step S60 to Step S64 are similar to those in the usage example 1.

The temperature at the time of charging the batteries is preferably higher than or equal to 0° C., for example, in which case high charge characteristics can be obtained.

This embodiment can be implemented in appropriate combination with the other embodiments.

### Embodiment 4

In this embodiment, a structure of a battery cell that can be used in the above embodiments is described. Unless otherwise specified, the battery cell described in this embodiment can be used for a battery for normal-temperature use or a battery for low-temperature use.

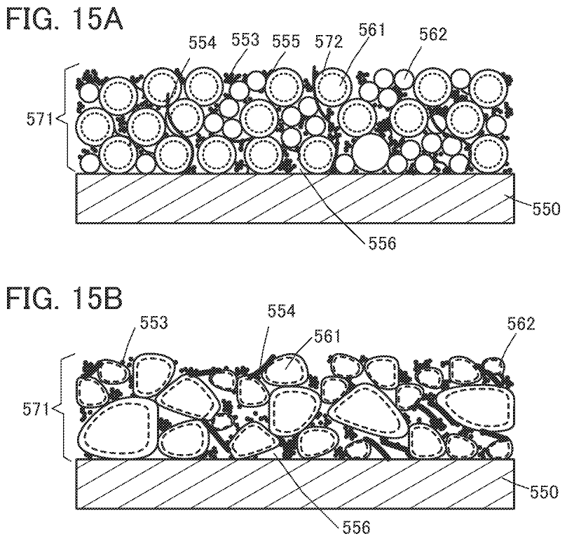

Specifically, a positive electrode of the battery cell is described with reference to FIG. 15A and FIG. 15B.

### Positive Electrode

The battery cell includes a positive electrode. FIG. 15A illustrates an example of a cross-sectional view of the positive electrode. The positive electrode contains a positive electrode active material layer 571 over a positive electrode current collector 550. The positive electrode active material layer 571 includes a positive electrode active material 561, a positive electrode active material 562, a binder (binding agent) 555, a conductive additive 553, and an electrolyte solution 556.

### Positive Electrode Current Collector

The positive electrode includes the positive electrode current collector 550. For the positive electrode current collector 550, a material having high conductivity can be used; specifically, a metal such as copper, gold, platinum, aluminum, iron, or titanium, an alloy of the metal, or the like is preferably used. Stainless steel can be given as an alloy of iron. For the positive electrode current collector 550, a metal or an alloy that does not dissolve at the potential of the positive electrode is preferably used. For the positive electrode current collector 550, an aluminum alloy to which an element that improves heat resistance, such as silicon, titanium, neodymium, scandium, or molybdenum, is added is preferably used. For the positive electrode current collector 550, a metal that forms silicide by reacting with silicon, which is for example the above-described titanium, is preferably used. Examples of the metal element that forms silicide by reacting with silicon include zirconium, hafnium, vanadium, niobium, tantalum, chromium, molybdenum, tungsten, cobalt, and nickel, in addition to the above-described titanium.

The thickness of the positive electrode current collector 550 is preferably greater than or equal to 5 μm and less than or equal to 30 μm, further preferably greater than or equal to 10 μm and less than or equal to 20 μm and is preferably a sheet-like shape or a plate-like shape. The positive electrode current collector 550 may be subjected to punching metal processing or expanded metal processing. The punching metal processing is perforation processing, and the expanded metal processing is cutting and stretching processing. When the punching metal processing and the expanded metal processing are performed, the positive electrode current collector 550 having a mesh shape provided with openings with a circular shape, an elliptical shape, a rhombus shape, or the like is obtained. With the use of the positive electrode current collector 550 having the openings, a lightweight battery cell can be obtained.

### Positive Electrode Active Material

The positive electrode includes a positive electrode active material. Although sometimes referred to as positive electrode active material particles, the positive electrode active material 561 and the positive electrode active material 562 illustrated in FIG. 15A are in any of a variety of forms other than a particle form. The positive electrode active material 561 and the positive electrode active material 562 may each be a primary particle or a secondary particle. Note that in this specification, a primary particle refers to a particle (lump) of the smallest unit having no grain boundary when being observed, for example, at a magnification of 5000 times with a SEM (scanning electron microscope) or the like. That is, the primary particle is a particle as a minimum unit. The secondary particle refers to a particle in which the primary particles aggregate, partially sharing the grain boundary (the circumference of the primary particle or the like), and which is independent of another particle. That is, the secondary particle has a grain boundary.

As each of the positive electrode active material 561 and the positive electrode active material 562, a material into and from which carrier ions can be inserted and extracted can be used. As the carrier ions, lithium ions, sodium ions, potassium ions, calcium ions, strontium ions, barium ions, beryllium ions, or magnesium ions can be used.

Examples of the material into and from which lithium ions can be inserted and extracted include lithium composite oxides with an olivine crystal structure, a layered rock-salt crystal structure, and a spinel crystal structure.

For example, a lithium composite oxide with an olivine crystal structure is represented by LiMPO₄ (here, M includes one or more of Fe, Mn, Ni, and Co). Since Fe and Mn are excellent in thermal stability, LiMPO₄ with M being either or both of Fe and Mn is suitable as the positive electrode active material. In the case where Fe is used as M, LiMPO₄ is expressed by LiFePO₄, which is referred to as LFP in some cases. LFP may be referred to as a composite oxide containing lithium, iron, and phosphorus and may contain an element other than the elements given as an example, or an element that does not contribute to capacitance.

A lithium composite oxide with a layered rock-salt crystal structure is, for example, represented by LiMO₂ (here, M includes one or more of Fe, Mn, Ni, and Co). In the case where Co is used as M, LiMO₂ is expressed by LiCoO₂, which is referred to as LCO or lithium cobalt oxide in some cases. LCO may be referred to as a composite oxide containing lithium and cobalt and may contain an element other than the elements described as an example, or an element that does not contribute to capacitance.

Lithium cobalt oxide may contain one or two or more elements selected from the group consisting of nickel, chromium, aluminum, iron, magnesium, molybdenum, zinc, zirconium, indium, gallium, copper, titanium, niobium, silicon, fluorine, phosphorus, and the like. Such an element is referred to as an additive element in some cases. The additive element is often positioned in a surface portion of the active material. The surface portion refers to a region from a surface of the active material to 50 nm, preferably to 30 nm, further preferably to 10 nm.

Furthermore, as a lithium composite oxide with a layered rock-salt crystal structure, there is a NiCoMn-based material represented by LiNiₓCo_{y}Mn_{z}O₂ (x>0, y>0, and 0.8<x+y+z<1.2). LiNiₓCo_{y}Mn_{z}O₂ (x>0, y>0, and 0.8<x+y+z<1.2) is referred to as NCM in some cases. In LiNiₓCo_{y}Mn_{z}O₂, for example, it is preferable to satisfy 0.1x<y<8x and 0.1x<z8x. As a specific example, x, y, and z preferably satisfy x:y:z=1:1:1 or the value in the neighborhood thereof. As another specific example, x, y, and z preferably satisfy x:y:z=5:2:3 or the value in the neighborhood thereof. As another specific example, x, y, and z preferably satisfy x:y:z=8:1:1 or the value in the neighborhood thereof. As another specific example, x, y, and z preferably satisfy x:y:z=9:0.5:0.5 or the value in the neighborhood thereof. As another specific example, x, y, and z preferably satisfy x:y:z=6:2:2 or the value in the neighborhood thereof. As another specific example, x, y, and z preferably satisfy x:y:z=1:4:1 or the value in the neighborhood thereof. NCM may be referred to as a lithium composite oxide containing Ni, Co, and Mn or may be referred to as a composite oxide containing Li, Ni, Co, and Mn.

In addition, NCM may contain one or two or more selected from calcium, boron, gallium, aluminum, boron, and indium at a concentration higher than or equal to 0.1 aT % and lower than or equal to 3 aT %. In some cases, calcium, boron, gallium, aluminum, boron, and indium at the above-described concentration are referred to as additive elements. The additive element is often positioned in the surface portion of the active material. The surface portion refers to a region from the surface of the active material to 50 nm, preferably to 30 nm, further preferably to 10 nm.

In addition, a NiCoMn-based lithium composite oxide containing aluminum as its main component is sometimes referred to as NCMA. In some cases, NCMA is referred to as a lithium composite oxide containing Ni, Co, Mn, and Al or is referred to as a composite oxide containing Li, Ni, Co, Mn, and Al.

In addition, a lithium composite oxide containing Ni and Co and containing aluminum as its main component is sometimes referred to as NCA. In some cases, NCA is referred to as a lithium composite oxide containing Ni, Co, and Al or is referred to as a composite oxide containing Li, Ni, Co, and Al.

For example, examples of a lithium composite oxide with a spinel crystal structure include a lithium manganese spinel (LiMn₂O₄).

Other examples of the material into and from which sodium ions can be inserted and extracted include NaFeO₂, NaNiO₂, NaCoO₂, NaMnO₂, NaVO₂, Na(NiₓMn_{1-X})O₂ (0<X<1), Na(FeₓMn_{1-X})O₂ (0<X<1), NaVPO₄F, Na₂FePO₄F, and Na₃V₂(PO₄)₃.

In addition, oxides such as V₂O₅ and Nb₂O₅ have been researched as positive electrode active materials.

The average particle diameter of the positive electrode active material 561 is greater than or equal to 1 μm and less than or equal to 50 μm, preferably greater than or equal to 5 μm and less than or equal to 30 μm. Here, a median diameter (D50) can be used as the average particle diameter, for example. Note that in the case of a lithium composite oxide represented by NCM, the positive electrode active material 561 exists in the form of a secondary particle in some cases. The secondary particle preferably satisfies the above-described average particle diameter. The secondary particle is regarded as a particle in which primary particles aggregate. In the case where the secondary particle is an aggregate of the primary particles that satisfy the above-described average particle diameter, the size of the secondary particle is preferably greater than or equal to 10 μm and less than or equal to 100 μm, further preferably greater than or equal to 20 μm and less than or equal to 80 μm.

The positive electrode active material 562 having a different particle size is further added in some cases to increase the filling density of the active material. “Having a different particle size” means having a different local maximum value of the average particle diameter or having a different median diameter (D50). The particle size of the positive electrode active material 562 is preferably greater than or equal to ⅙ and less than or equal to 1/10 of the particle size of the positive electrode active material 561.

The charging density can be increased without the positive electrode active material 562. When the positive electrode active material 562 is not included, the number of formation steps can be reduced and furthermore, costs can be reduced.

The active material of the positive electrode active material 561 may be the same as or different from the active material of the positive electrode active material 562. The same active materials contain the same main material but may be different in the presence of an additive element or the like. The different active materials contain different main materials.

The positive electrode active material 561 and the positive electrode active material 562 may include an additive element, and the additive element is preferably positioned in the surface portion. The additive element is preferably unevenly distributed in the surface portion. Uneven distribution refers to a state where the additive element exists non-uniformly or unevenly and includes a state where the concentration of the additive element is higher in the surface portion. Uneven distribution may be expressed as segregation or precipitation.

FIG. 15A illustrates a surface portion 572 of the positive electrode active material 561. In a cross-sectional view, the surface portion 572 extends 50 nm or less, preferably 35 nm or less, further preferably 20 nm or less, most preferably 10 nm or less inward from the surface of the positive electrode active material 561. Although not illustrated, the positive electrode active material 562 may include a surface portion similar to the surface portion 572.

The structure of the active material including the surface portion 572 is referred to as a core shell structure in some cases.

Although FIG. 15A illustrates the positive electrode active material 561 in a particle form, the positive electrode active material 561 is not necessarily in a particle form. As illustrated in FIG. 15B, the cross-sectional shape of the positive electrode active material 561 may be an ellipse, a rectangle, a trapezoid, a pyramid, a quadrilateral with rounded corners, or an asymmetrical shape. Note that by pressing in the formation process of the positive electrode, the particulate positive electrode active material sometimes changes in shape to have the shape as illustrated in FIG. 15B. The other components in FIG. 15B are similar to those in FIG. 15A and are not described.

### Binder

As illustrated in FIG. 15A, the positive electrode includes the binder 555. The binder 555 is provided to prevent the positive electrode active material 561, the positive electrode active material 562, or the conductive additive 553 from slipping off from the positive electrode current collector 550. The binder 555 has a function of fixing the positive electrode active material 561 and the conductive additive 553 to each other. Similarly, the binder 555 also has a function of fixing the positive electrode active material 562 and the conductive additive 553 to each other. Thus, there are the binder 555 positioned in contact with the positive electrode current collector 550, the binder 555 positioned between the positive electrode active material 561 and the conductive additive 553, the binder 555 positioned between the positive electrode active material 562 and the conductive additive 553, and the binder 555 positioned to be intertwined with the conductive additive 553.

As the binder 555, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder 555, for example, water-soluble polymers are preferably used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder 555, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder 555.

For example, a material having a significant viscosity modifying effect and another material may be used in combination as the binder 555. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide that is, for example, a cellulose derivative such as carboxymethyl cellulose (CMC), methyl cellulose, ethyl cellulose, hydroxypropyl cellulose, diacetyl cellulose, or regenerated cellulose or starch, can be used.

Note that a cellulose derivative such as carboxymethyl cellulose has a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs in the case where the passivation film is formed on the active material surface, for example. It is further desirable that the passivation film can conduct lithium ions while inhibiting electrical conduction.

### Conductive Additive

Since the positive electrode active material 561 being a composite oxide may have high resistance, it is difficult to collect a current from the positive electrode active material 561 to the positive electrode current collector 550. In that case, the positive electrode contains the conductive additive 553 and a conductive additive 554 as illustrated in FIG. 15A, and the conductive additive 553 and the conductive additive 554 have a function of giving aid to a current path between the positive electrode active material 561 and the positive electrode current collector 550, a current path between a plurality of the positive electrode active materials 561, a current path between a plurality of positive electrode active materials and the positive electrode current collector 550, and the like.

To serve such a function, the conductive additive 553 and the conductive additive 554 preferably contain a material having a lower resistance than the positive electrode active material 561. Furthermore, some of the conductive additive 553 and the conductive additive 554 are preferably placed so as to be in contact with the positive electrode current collector 550, and some of the conductive additive 553 and the conductive additive 554 are preferably placed in a gap between the positive electrode active materials 561. A conductive additive is also referred to as a conductivity-imparting agent or a conductive material owing to its role,

Note that the positive electrode may have a structure containing either one of the conductive additive 553 and the conductive additive 554.

As the conductive additive, a carbon material or a metal material is typically used. The conductive additive 553 is in a particle form; examples of the particulate conductive additive include carbon black (e.g., furnace black, acetylene black, or graphite). Carbon black mostly has a smaller grain diameter than the positive electrode active material 561. The conductive additive 554 is in a fibrous form; examples of the fibrous conductive additive include carbon nanotube (CNT) and VGCF (registered trademark). Other conductive additives are in a sheet form; examples of the sheet-shaped conductive additive include multilayer graphene. The sheet-shaped conductive additive sometimes looks like a thread in observation of a cross section of a positive electrode.

The conductive additive 553 in a particle form can enter a gap of the positive electrode active material 561 and easily aggregates. Thus, the particulate conductive additive 553 can give aid to a conductive path between positive electrode active materials provided close to each other. Although having a bent region, the conductive additive 554 in a fiber form is larger than the positive electrode active material 561. The conductive additive 554 in a fiber form can thus give aid to not only a conductive path between adjacent positive electrode active materials but also a conductive path between positive electrode active materials located apart or separate from each other. Conductive additives in two or more forms as described above are preferably mixed.

For example, a sheet-shaped conductive additive may be used instead of the fibrous conductive additive 554. In the case of using multilayer graphene as the sheet-shaped conductive additive and carbon black as a particulate conductive additive, the weight of the carbon black is preferably 1.5 times to 20 times, further preferably 2 times to 9.5 times the weight of graphene in the state of slurry where these are mixed.

When the mixing ratio between multilayer graphene and carbon black is in the above-described range, carbon black does not aggregate and is easily dispersed. When the mixing ratio between multilayer graphene and carbon black is in the above-described range, the electrode density can be higher than that of the time when only carbon black is used as a conductive additive. As the electrode density is higher, the capacity per unit weight can be higher.

Moreover, when the mixing ratio between multilayer graphene and carbon black is in the above-described range, fast charging is possible.

### Electrolyte Solution

The battery cell includes an electrolyte solution. In the electrolyte solution described in this embodiment, an organic solvent is used as a solvent, and an electrolyte (lithium salt) is dissolved in the organic solvent. Note that the organic solvent is not limited to an organic solvent that is in a liquid form at normal temperature, and a solid electrolyte that is in a solid form at normal temperature can also be used. Alternatively, an electrolyte containing both an organic solvent that is in a liquid form at normal temperature and a solid electrolyte that is in a solid form at normal temperature (this is referred to as a semisolid electrolyte on the basis of the state) can be used. For example, the positive electrode in FIG. 15A is the electrolyte solution 556. Although not illustrated in FIG. 15A, a negative electrode described later also includes the electrolyte solution 556.

### Examples of Organic Solvent for Normal-Temperature Use

Examples of the organic solvent for normal-temperature use are described below.

As the organic solvent for normal-temperature use, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio (also referred to as proportions and sometimes expressed in a volume ratio).

As the organic solvent for normal-temperature use, one or more ionic liquids (normal temperature molten salts) having non-flammability and non-volatility can be used. The use of an ionic liquid can prevent a battery cell from expanding, exploding, or catching fire even when the battery cell internally shorts out or the internal temperature increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion used for the ionic liquid include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the lithium salt dissolved in the above-described organic solvent for normal-temperature use, for example, one or two or more selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and the like can be used.

The above-described organic solvent for normal-temperature use may contain an additive. For example, vinylene carbonate (VC), propane sultone (PS), tert-butylbenzene (TBB), fluoroethylene carbonate (FEC), lithium bis (oxalate) borate (LiBOB), a dinitrile compound such as succinonitrile or adiponitrile, or the like may be added as the additive to the above-described organic solvent or ionic liquid. The concentration of the additive in the whole electrolyte solution is, for example, higher than or equal to 0.1 wt % and lower than or equal to 5 wt %. It is particularly preferable to use VC or LiBOB because it enables favorable film formation over the active material or the like.

As the organic solvent for normal-temperature use, a polymer gel electrolyte may be used. When a polymer gel electrolyte is used, safety against liquid leakage and the like is improved. Furthermore, the battery cell can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

As the polymer, a polymer having a polyalkylene oxide structure, such as polyethylene oxide (PEO); PVDF; polyacrylonitrile; a copolymer containing any of them; or the like can be used, for example. For example, PVDF-HFP, which is a copolymer of PVDF and hexafluoropropylene (HFP), can be used. The formed polymer may be porous.

For the battery for normal-temperature use, a solid electrolyte containing an inorganic material can be used. For example, a sulfide-based solid electrolyte, an oxide-based solid electrolyte, a halide-based solid electrolyte, or the like can be used. Alternatively, a solid electrolyte containing a high-molecular material such as a PEO (polyethylene oxide)-based high-molecular material can be used. When the solid electrolyte is used, a separator and a spacer do not need to be provided. Furthermore, the battery cell can be solidified; therefore, there is no possibility of liquid leakage and thus the safety of the battery cell is dramatically improved.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S.30P₂S530Li₂S.26B₂S₃.44LiI, 63Li₂S.36SiS₂.1Li₃PO₄, 57Li₂S.38SiS₂.5Li₄SiO₄, or 50Li₂S.50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₊ₓAlₓTi₂₋ₓ(PO₄)₃), a material having a garnet crystal structure (e.g., Li₇La₃Zr₂O₁₂), a material having a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃ (0[x[1) having a NASICON crystal structure (hereinafter, LATP) is preferable because LATP contains aluminum and titanium, each of which is the same element as the main material or the additive element of the positive electrode active material used in one embodiment of the present invention, and thus a synergistic effect of improving the cycle performance is expected. Moreover, higher productivity due to the reduction in the number of steps is expected. Note that in this specification and the like, a NASICON crystal structure refers to a compound that is represented by M₂(AO₄)₃ (M: transition metal; A: S, P, As, Mo, W, or the like) and has a structure in which MO₆ octahedra and AO₄ tetrahedra that share corners are arranged three-dimensionally.

### Examples of Organic Solvent for Low-Temperature Use

Examples of an organic solvent for low-temperature use are described below.

An organic solvent for low-temperature use contains ethylene carbonate (EC), ethyl methyl carbonate (EMC), and dimethyl carbonate (DMC). When a total content of the ethylene carbonate, the ethyl methyl carbonate, and the dimethyl carbonate is 100 vol %, an organic solvent in which the volume ratio between the ethylene carbonate, the ethyl methyl carbonate, and the dimethyl carbonate is x:y:100−x−y (where 5≤x≤35 and 0<y<65) can be used. More specifically, an organic solvent containing EC, EMC, and DMC at EC:EMC:DMC=30:35:35 (volume ratio) can be used. Note that the volume ratio may be a volume ratio of the electrolyte solution before mixing, and the electrolyte solution may be mixed at room temperature (typically 25° C.).

EC is cyclic carbonate and has high relative dielectric constant, and thus has an effect of promoting dissociation of a lithium salt. Meanwhile, the EC has high viscosity and has a high freezing point (melting point) of 38° C.; thus, EC is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte c formed using an organic solvent in which EC, EMC, and DMC having such physical properties are mixed in a volume ratio of x:y:100−x−y (5≤x≤35 and 0<y<65) at 25° C. when the total content of these three organic solvents is 100 vol % has a characteristic in which the freezing point is lower than or equal to −40° C.

A general electrolyte used for a battery cell is solidified at approximately −20° C.; thus, it is difficult to form a battery that can be charged and discharged at −40° C. Since the electrolyte described above as the organic solvent for low-temperature use has a freezing point lower than or equal to −40° C., a battery cell that can be charged and discharged even in an extremely low-temperature environment such as at −40° C. can be obtained.

A lithium salt dissolved in the organic solvent for low-temperature use can be selected from the lithium salts described as the lithium salt for normal-temperature use.

The additive contained in the organic solvent for low-temperature use can be selected from the additives described as the organic solvent for normal-temperature use.

### Negative Electrode

The battery cell includes a negative electrode. The negative electrode includes a negative electrode active material layer and a negative electrode current collector. The negative electrode active material layer includes a negative electrode active material, and may further contain a conductive additive and a binder.

### Negative Electrode Current Collector

The negative electrode includes a negative electrode current collector. For the negative electrode current collector, a material similar to that of the positive electrode current collector can be used.

### Negative Electrode Active Material

The negative electrode includes a negative electrode active material. As the negative electrode active material, an alloy material or a carbon material can be used, for example.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, are referred to as alloy materials in some cases.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can show a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M is Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ described above or Cr₃O₈. Note that even in the case of using a material containing lithium ions as a positive electrode active material, the nitride containing lithium and a transition metal can be used as the negative electrode active material by extracting lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

As another form of the negative electrode of the present invention, a negative electrode that does not contain a negative electrode active material can be used. In a battery cell including the negative electrode that does not contain a negative electrode active material, lithium can be deposited on a negative electrode current collector at the time of charging, and lithium on the negative electrode current collector can be dissolved at the time of discharging. Thus, lithium is on the negative electrode current collector in the states except for the completely discharged state.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, or a polymer-based solid electrolyte can be used, for example. Among them, a film of the polymer-based solid electrolyte can be uniformly formed over the negative electrode current collector relatively easily, and thus is suitable as the film for making lithium deposition uniform.

In the case where the negative electrode that does not contain a negative electrode active material is used, a negative electrode current collector having unevenness can be used. In the case where the negative electrode current collector having unevenness is used, a depression of the negative electrode current collector becomes a cavity in which lithium contained in the negative electrode current collector is easily deposited, so that the lithium can be inhibited from having a dendrite-like shape when being deposited.

### Conductive Additive

The negative electrode contains a conductive additive. As the conductive additive contained in the negative electrode, the conductive additive contained in the positive electrode can be used.

### Separator

The battery cell includes a separator positioned between the positive electrode and the negative electrode. The separator insulates the positive electrode and the negative electrode from each other. As the separator, a stable separator whose material has an excellent liquid-retaining property with respect to an electrolyte is preferably used. As the separator, a separator formed using, for example, a fiber containing cellulose, such as paper, nonwoven fabric, glass fiber, ceramics, or synthetic fiber containing nylon (polyamide), vinylon (polyvinyl alcohol-based fiber), polyester, polyimide, acrylic, polyolefin, or polyurethane can be used.

The separator preferably has a porosity higher than or equal to 30% and lower than or equal to 85%, further preferably higher than or equal to 45% and lower than or equal to 65%. High porosity is preferred because it facilitates impregnation with an electrolyte solution. The porosity of the separator on the positive electrode side may be different from that on the negative electrode side, and the porosity on the positive electrode side is preferably higher than the porosity on the negative electrode side. Examples of a structure with different porosities are a single material having different porosities and different kinds of materials with different porosities. In the case where different kinds of materials are used, stacking these materials allows the separator to have different porosities.

The separator preferably has an average pore size greater than or equal to 40 nm and less than or equal to 3 μm, further preferably greater than or equal to 70 nm and less than or equal to 1 μm. A large average pore size is preferred because it facilitates passage of carrier ions. The average pore size of the separator on the positive electrode side may be different from that on the negative electrode side, and the average pore size on the positive electrode side is preferably larger than the average pore size on the negative electrode side. Examples of a structure with different average pore sizes are a single material having different average pore sizes and different kinds of materials with different average pore sizes. In the case where different kinds of materials are used, stacking these materials allows the separator to have different average pore sizes.

The thickness of the separator is preferably greater than or equal to 5 μm and less than or equal to 200 μm, further preferably greater than or equal to 5 μm and less than or equal to 100 μm.

The separator preferably has a heat resistance temperature higher than or equal to 200° C.

A separator including a polyimide and having a thickness greater than or equal to 10 μm and less than or equal to 50 μm and a porosity higher than or equal to 75% and lower than or equal to 85% is preferably used to increase the output characteristics of the secondary battery.

The separator may be processed into a bag-like shape to enclose or sandwich any one of the positive electrode and the negative electrode.

As the separator having a multilayer structure, an organic material film of polypropylene, polyethylene, or the like coated with a ceramic-based material, a fluorine-based material, a polyamide-based material, a mixture thereof, or the like can be used. As the ceramic-based material, aluminum oxide particles or silicon oxide particles can be used, for example. As the fluorine-based material, PVDF or polytetrafluoroethylene can be used, for example. As the polyamide-based material, nylon or aramid (meta-based aramid or para-based aramid) can be used, for example.

When the surface of the separator is coated with the ceramic-based material, the oxidation resistance is improved; hence, deterioration of the separator in high-voltage charging and discharging can be suppressed and accordingly, the reliability of the battery cell can be improved. When the surface of the separator is coated with the fluorine-based material, the separator is easily brought into close contact with an electrode, resulting in high output characteristics. When the surface of the separator is coated with the polyamide-based material, in particular, aramid, heat resistance is improved; hence, the safety of the battery cell can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of such a separator having a multilayer structure, which can have the functions of the materials, insulation between the positive electrode and the negative electrode can be ensured and the safety of the battery cell can be kept even when the total thickness of the separator is small. This is preferable because in that case, the capacity of the battery cell per volume can be increased.

### Exterior Body

The battery cell includes an exterior body. For the exterior body, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

Although the structure and the like of the battery cell that can be used in the above embodiments have been described above as examples in this embodiment, the present invention is not construed as being limited to the above examples.

This embodiment can be used in appropriate combination with the other embodiments.

### Embodiment 5

In this embodiment, a manufacturing method 1 of a positive electrode active material that can be used in the above embodiments is described. Unless otherwise specified, the manufacturing method 1 of the positive electrode active material described in this embodiment can be used for a battery for normal-temperature use or a battery for low-temperature use.

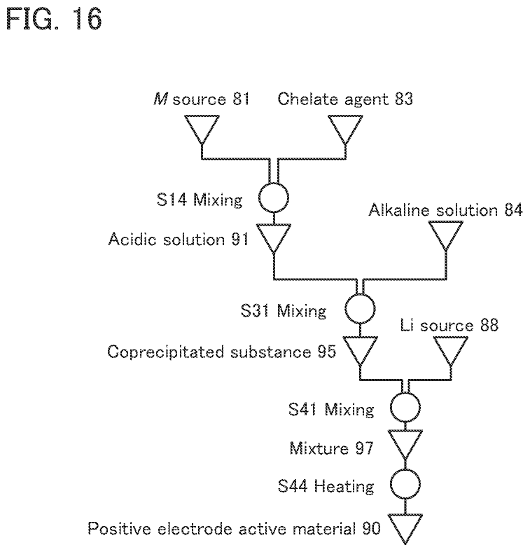

Specifically, a method for manufacturing a positive electrode active material by a coprecipitation method is described with reference to FIG. 16 and the like.

### Manufacturing Method 1 of Positive Electrode Active Material

### Transition Metal M Source

A transition metal M source 81 (referred to as an M source in the drawing) illustrated in FIG. 16 is described. As the transition metal M, at least one of nickel, cobalt, and manganese can be used, for example. As the transition metal M, for example, nickel alone; two kinds of metals of cobalt and manganese; two kinds of metals of nickel and cobalt; or three kinds of metals of nickel, cobalt, and manganese may be used.

When nickel, cobalt, and manganese are used, the mixed ratio of nickel, cobalt, and manganese is preferably set such that a layered rock-salt crystal structure can be formed.

It is particularly preferable that the transition metal M contain a large amount of nickel, in which case the cost of the raw material may be lower than that in the case of containing a large amount of cobalt and charge and discharge capacity per weight may be increased. Such an active material is suitable for an electric vehicle. For example, the proportion of nickel in the transition metals M preferably exceeds 25 atomic %, is further preferably 60 atomic % or higher, and is still further preferably 80 atomic % or higher. However, when the proportion of nickel is too high, the chemical stability and heat resistance might decrease. Therefore, the proportion of nickel in the transition metals M is preferably 95 atomic % or lower.

Cobalt is preferably contained as the transition metal M, in which case the average discharge voltage is high and a battery cell can be highly reliable because cobalt contributes to stabilization of a layered rock-salt structure. Such an active material is suitable for an electric vehicle.

Meanwhile, the price of cobalt is higher and more unstable than those of nickel and manganese; thus, a too high proportion of cobalt might increase the manufacturing cost. For this reason, the proportion of cobalt in the transition metals M is preferably higher than or equal to 2.5 atomic % and lower than or equal to 34 atomic %, for example. Note that cobalt is not necessarily contained as the transition metal M.

The transition metal M preferably contains manganese, in which case heat resistance and chemical stability are improved. Such an active material is suitable for an electric vehicle.

However, a too high proportion of manganese tends to decrease discharge voltage and discharge capacity. For this reason, the proportion of manganese in the transition metals M is preferably higher than or equal to 2.5 atomic % and lower than or equal to 34 atomic %, for example. Note that manganese is not necessarily contained as the transition metal M.

As the transition metal M source 81, an aqueous solution containing the transition metal M is preferably prepared. As a nickel source, an aqueous solution of nickel salt, e.g., nickel sulfate, nickel chloride, nickel nitrate, or hydrate of any of these can be used. Alternatively, an aqueous solution of an organic acid salt of nickel, such as nickel acetate, or hydrate of the organic acid salt of nickel can be used. Alternatively, an aqueous solution of nickel alkoxide or an organonickel complex can be used. In this specification and the like, the term “organic acid salt” denotes a compound of a metal and an organic acid such as an acetic acid, a citric acid, an oxalic acid, a formic acid, or a butyric acid.

As a cobalt source, an aqueous solution of cobalt salt, e.g., cobalt sulfate, cobalt chloride, cobalt nitrate, or a hydrate thereof can be used. Alternatively, an aqueous solution of an organic acid salt of cobalt, such as cobalt acetate, or hydrate of the organic acid salt of cobalt can be used. Alternatively, an aqueous solution of cobalt alkoxide or an organic cobalt complex can be used.

As a manganese source, an aqueous solution of manganese salt, such as manganese sulfate, manganese chloride, or manganese nitrate, or hydrate of any of these can be used. Alternatively, an aqueous solution of an organic acid salt of manganese, such as manganese acetate, or hydrate of the organic acid salt of manganese can be used. Alternatively, an aqueous solution of manganese alkoxide or an organomanganese complex can be used.

In this embodiment, an aqueous solution in which nickel sulfate, cobalt sulfate, and manganese sulfate are dissolved in pure water is prepared as the transition metal M source 81. At this time, nickel, cobalt, and manganese are weighed such that the atomic ratio Ni:Co:Mn being 8:1:1 or in the neighborhood thereof is satisfied.

### Additive Element Source

Although not shown, an additive element source may be prepared in addition to the transition metal M source 81. An additive element added to the transition metal M source 81 is referred to as a first additive element. The specific first additive element preferably contains one or more selected from gallium, aluminum, boron, and indium, for example.

When the first additive element is gallium, the additive element source can be referred to as a gallium source. As the gallium source, a compound containing gallium can be used. As the compound containing gallium, for example, gallium sulfate, gallium chloride, gallium nitrate, or a hydrate thereof can be used. Alternatively, gallium alkoxide or an organogallium complex may be used as the compound containing gallium. Further alternatively, organic acid of gallium such as gallium acetate, or a hydrate thereof may be used as the compound containing gallium.

When the first additive element is aluminum, the additive element source can be referred to as an aluminum source. As the aluminum source, a compound containing aluminum can be used. Aluminum sulfate, aluminum chloride, aluminum nitrate, or a hydrate thereof can be used as the compound containing aluminum, for example. Alternatively, aluminum alkoxide or an organoaluminum complex may be used as the compound containing aluminum. Further alternatively, organic acid of aluminum such as aluminum acetate, or a hydrate thereof may be used as the compound containing aluminum.

When the first additive element is boron, the additive element source can be referred to as a boron source. As the boron source, a compound containing boron can be used. As the compound containing boron, for example, boric acid or a borate can be used.

When the first additive element is indium, the additive element source can be referred to as an indium source. As the indium source, a compound containing indium can be used. As the compound containing indium, for example, indium sulfate, indium chloride, indium nitrate, or a hydrate thereof can be used. Alternatively, indium alkoxide or an organoindium complex may be used as the compound containing indium. Further alternatively, organic acid of indium such as indium acetate, or a hydrate thereof may be used as the compound containing indium.

When a solution is used as the first additive element source, an aqueous solution containing the above compound is prepared.

### Chelate Agent

A chelate agent 83 illustrated in FIG. 16 is described. Examples of constituent materials of the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. Note that an aqueous solution obtained by dissolving any of these in pure water is a chelate agent, and an aqueous solution obtained by dissolving glycine is sometimes referred to as a glycine aqueous solution. The chelate agent serves as a complexing agent to form a chelate compound, and is preferred to a general complexing agent. Needless to say, a complexing agent other than the chelate agent may be used, and ammonia water can be used as the complexing agent.

The use of the chelate agent is preferable to facilitate control of the pH in the reaction vessel in obtaining a coprecipitated substance, for example, a cobalt compound. Furthermore, the use of the chelate agent is preferable also because the chelate agent suppresses generation of unnecessary crystal nuclei and promotes crystal growth. Since generation of unnecessary crystal nuclei is suppressed to inhibit generation of fine particles, a composite oxide with good particle size distribution can be obtained. Furthermore, the use of the chelate agent can slow an acid-base reaction, so that the reaction gradually proceeds to form a nearly spherical secondary particle.

Glycine has a function of keeping the pH constant and greater than or equal to 9 and less than or equal to 10 or the vicinity of the range. Using a glycine aqueous solution as the chelate agent is preferable to facilitate control of the pH in the reaction vessel in obtaining the cobalt compound. Furthermore, the concentration of glycine in the glycine aqueous solution is preferably greater than or equal to 0.05 mol/L and less than or equal to 0.09 mol/L in the aqueous solution.

### Pure Water

The aqueous solution used in this embodiment is preferably pure water. The pure water is water with a resistivity of 1 MΩ·cm or higher, preferably water with a resistivity of 10 MΩ·cm or higher, further preferably water with a resistivity of 15 MΩ·cm or higher. Water satisfying the above-described resistivity has high purity and contains an extremely small amount of impurities.

### Step S14

Next, in Step S14 illustrated in FIG. 16, the transition metal M source 81 and the chelate agent 83 are mixed to form an acidic solution 91.

### Alkaline Solution

Next, an alkaline solution 84 illustrated in FIG. 16 is described. For example, an aqueous solution containing sodium hydroxide, potassium hydroxide, lithium hydroxide, or ammonia is used as the alkaline solution, and the alkaline solution is not limited to the aqueous solution as long as it functions as a pH adjuster. An aqueous solution in which two or more kinds selected from sodium hydroxide, potassium hydroxide, and lithium hydroxide are dissolved in water may be used, for example. The above-described pure water is preferably used as the water.

Water or an aqueous solution may be prepared together with the alkaline solution 84. Water or an aqueous solution is described as a filling liquid or an adjustment liquid in some cases, and refers to an aqueous solution in the initial state of the reaction. The above-described pure water is preferably used as the water. A chelate agent containing the above-described pure water may be used as the aqueous solution. In the case where a chelate agent is used, effects described above in <Chelate agent> are produced. Note that water or an aqueous solution is not necessarily prepared.

### Step S31

Next, Step S31 illustrated in FIG. 16 is described. In Step S31, the acidic solution 91 and the alkaline solution 84 are mixed. By the mixing, the acidic solution 91 and the alkaline solution 84 react with each other, whereby a coprecipitated substance 95 can be obtained.

The above reaction in Step 31 is referred to as a neutralization reaction, an acid-base reaction, or a coprecipitation reaction in some cases. The obtained coprecipitated substance 95 is referred to as a precursor of the positive electrode active material in some cases.

### Reaction Conditions

In the case where the acidic solution 91 and the alkaline solution 84 are mixed according to a coprecipitation method, the pH of the reaction system is set to be higher than or equal to 9 and less than or equal to 11, preferably greater than or equal to 9.8 and less than or equal to 10.3. For example, in the case where the acidic solution 91 is put in a reaction container or the like (e.g., a beaker) and the alkaline solution 84 is dropped into the reaction container, the pH of the aqueous solution in the reaction container preferably satisfies or maintains the range of the above-described conditions. In the case where the value of the pH of the aqueous solution in the reaction container is changed by dropping of the alkaline solution 84, “maintaining the range of the above-described conditions” means that the pH of the aqueous solution in the reaction container satisfies the above-described range after a lapse of a certain time from the dropping. The certain time is longer than or equal to 1 second and shorter than or equal to 5 seconds, preferably longer than or equal to 1 second and shorter than or equal to 3 seconds. Likewise, also in the case where the alkaline solution 84 is put in a reaction container and the acidic solution 91 is dropped, the pH of the aqueous solution in the reaction container preferably satisfies or maintains the range of the above-described conditions. The dropping rate of the acidic solution 91 or the alkaline solution 84 is preferably higher than or equal to 0.2 mL/min and lower than or equal to 0.8 mL/min in consideration of easy control of pH conditions.

The alkaline solution 84 or the acidic solution 91 in the reaction container is preferably stirred with a stirring means. As the stirring means, a stirrer can be used; specifically, a stirrer having an impeller can be used. The stirrer can be provided with two to six impellers; for example, when a stirrer with four impellers is employed, the four impellers may be arranged to form a cross shape seen from above. The rotation number of the stirring means is preferably greater than or equal to 800 rpm and less than or equal to 1200 rpm.

The temperature of the alkaline solution 84 or the acidic solution 91 in the reaction container is adjusted to be higher than or equal to 50° C. and lower than or equal to 90° C. After the above-described temperature is reached, dropping of one of the alkaline solution 84 and the acidic solution 91 is preferably started.

The reaction container preferably has an inert atmosphere. For example, in the case of a nitrogen atmosphere, a nitrogen gas is preferably introduced at a flow rate of more than or equal to 0.5 L/min. and 2 L/min.

In the reaction vessel, a reflux condenser may be placed. The nitrogen gas can be released from the reaction container with use of the reflux condenser. Water generated by reflux cooling can be returned to the reaction container.

Through the above reaction, a cobalt compound is, for example, precipitated as the coprecipitated substance 95 in the reaction container. To collect the coprecipitated substance 95, filtration is preferably performed. After a reaction product precipitated in the reaction container is washed with pure water, filtration is preferably newly performed with an organic solvent having a low boiling point (e.g., acetone). Suction filtration is preferably used as the filtration.

It is preferable that the coprecipitated substance 95 after the filtration be further dried. For example, drying is performed in a vacuum atmosphere at higher than or equal to 60° C. and lower than or equal to 90° C. for longer than or equal to 0.5 hours and shorter than or equal to 3 hours. The coprecipitated substance 95 may be obtained through this procedure.

The cobalt compound, which is the coprecipitated substance 95, is preferably cobalt hydroxide (e.g., Co(OH)₂). The cobalt hydroxide after the filtration is obtained in the state of secondary particles which are aggregations of primary particles.

### Lithium Source

Next, a lithium compound is prepared as a lithium source 88 (expressed as Li source in the drawing) illustrated in FIG. 16. Lithium hydroxide, lithium carbonate, lithium oxide, or lithium nitrate is prepared as the lithium compound. For example, when cobalt hydroxide is obtained as the coprecipitated substance 95, lithium hydroxide can be used as the lithium compound.

The lithium compound is preferably ground. The mortar is preferably made of a material that does not release impurities; specifically, a mortar made of alumina with a purity higher than or equal to 90 wt %, preferably higher than or equal to 99 wt % is used. Alternatively, a wet grinding method using a ball mill may be employed. In a wet grinding method, acetone can be used as a solvent.

### Step S41

Next, in Step S41 illustrated in FIG. 16, the coprecipitated substance 95 and the lithium source 88 are mixed. After that, a mixed mixture 97 is obtained. A planetary centrifugal mixer is preferably used as a unit that mixes the coprecipitated substance 95 and the lithium source 88. Media are not used in the planetary centrifugal mixer, and thus grinding is not performed in many cases.

When the coprecipitated substance 95 and the lithium source 88 are ground at the same time as the mixing, a ball mill or a bead mill can be used. Alumina balls or zirconia balls can be used as media of the ball mill or the bead mill. A centrifugal force is applied to the media in the ball mill or the bead mill, and thus microparticulation is possible. In the case where contamination from the media and the like is a concern, it is preferable that the zirconia balls be used.

Dry grinding and wet grinding can be used when grinding is concurrently performed. Regarding dry grinding, grinding is performed in an inert gas or in air, and a particle can be ground to a particle diameter less than or equal to 3.5 μm, preferably less than or equal to 3 μm. Regarding wet grinding, grinding is performed in a liquid, and a particle can be ground to nano size in particle diameter. That is, wet grinding is preferably used to obtain a small particle diameter.

In this manner, the mixture 97 is obtained.

### Step S44

Next, in Step S44 illustrated in FIG. 16, the mixture is heated. Step S44 is referred to as main baking in some cases. After the heating, a composite oxide can be obtained as a positive electrode active material 90. The positive electrode active material 90 can reflect the shape of the coprecipitated substance 95 that is the precursor.

### Heating Conditions

The heating temperature is preferably higher than or equal to 700° C. and lower than 1100° C., further preferably higher than or equal to 800° C. and lower than or equal to 1000° C., still further preferably higher than or equal to 800° C. and lower than or equal to 950° C. When a cobalt oxide is manufactured through this heat treatment, heating is performed at a temperature at which at least the coprecipitated substance 95 and the lithium source 88 are diffused mutually. Because of the temperature, Step S54 is referred to as main baking.

The heating time can be longer than or equal to 1 hour and shorter than or equal to 100 hours, for example, and is preferably longer than or equal to 2 hours and shorter than or equal to 20 hours.

The heating atmosphere is preferably an atmosphere containing oxygen or an oxygen-containing atmosphere that is what is called dry air with little water (e.g., a dew point is lower than or equal to −50° C., preferably lower than or equal to −80° C.).

For example, in the case where the heating is performed at 750° C. for 10 hours, the temperature rising rate is preferably greater than or equal to 150° C./h and less than or equal to 250° C./h. The flow rate of dry air that can form a dry atmosphere is preferably greater than or equal to 3 L/min and less than or equal to 10 L/min. The temperature decreasing time from a specified temperature to room temperature is preferably longer than or equal to 10 hours and shorter than or equal to 50 hours. The temperature decreasing rate can be calculated from the temperature decreasing time or the like.

A crucible, a sagger, a setter, or a container used in the heating is preferably made of a material that does not release impurities. For example, a crucible made of alumina with a purity of 99.9% is preferably used. In the case of mass production, a sagger made of mullite cordierite (Al₂O₃, SiO₂, and MgO) is preferably used.

It is preferable to collect the heated materials after the materials are transferred from the crucible to a mortar in order to prevent impurities from entering the materials. The mortar is preferably made of a material that does not release impurities; specifically, a mortar made of alumina or zirconia with a purity higher than or equal to 90%, preferably higher than or equal to 99% is preferably used.

As described above, the positive electrode active material 90 can be manufactured. According to the manufacturing method 1, NCM can be obtained as the positive electrode active material 90. NCM is referred to as a composite oxide in some cases.

Following the manufacturing method 1 results in fewer impurities contained in the positive electrode active material 90 and is preferable. However, sulfur might be detected from the positive electrode active material 90 in the case where a sulfide is used as a starting material. With use of GD-MS, ICP-MS, or the like, elements of the positive electrode active material 90 can be analyzed to measure the concentration of sulfur.

As described above, although an example in which the positive electrode active material that can be used in the above embodiments is formed by a coprecipitation method is described in this embodiment, the present invention should not be construed as being limited to the above-described example.

This embodiment can be used in appropriate combination with the other embodiments.

### Embodiment 6

In this embodiment, a manufacturing method 2 of a positive electrode active material that can be used in the above embodiments is described. Unless otherwise specified, the manufacturing method 2 of the positive electrode active material described in this embodiment can be used for a battery for normal-temperature use or a battery for low-temperature use.

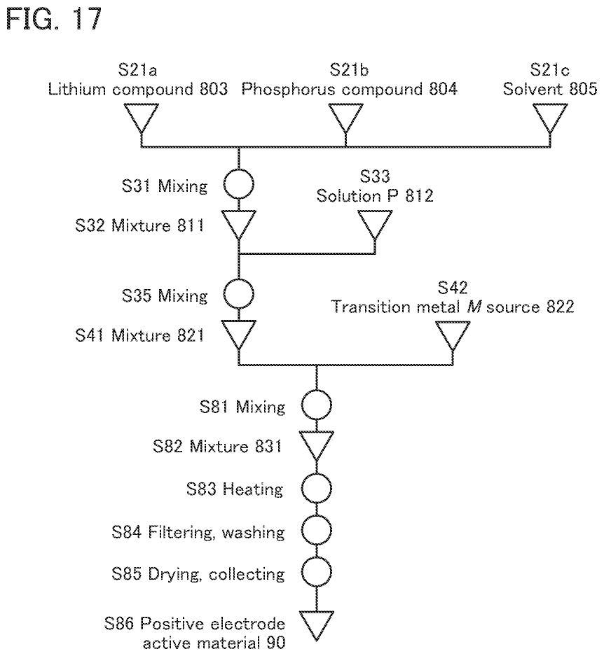

Specifically, a method for manufacturing a positive electrode active material by a liquid-phase method is described with reference to FIG. 17 and the like. The manufacturing method is described.

### Manufacturing Method 2 of Positive Electrode Active Material

In Step S21a in FIG. 17, a lithium compound 803 is prepared. In Step S21b, a phosphorus compound 804 is prepared.

Here, the atomic ratio of lithium to a transition metal M and phosphorus of a composite oxide that is preferably obtained as an after-mentioned positive electrode active material 90 is x:y:z. In order to obtain LiMPO₄, for example, x:y:z=1:1:1 is satisfied.

Typical examples of the lithium compound include lithium chloride (LiCl), lithium acetate (CH₃COOLi), lithium oxalate ((COOLi)₂), lithium carbonate (Li₂CO₃), and lithium hydroxide monohydrate (LiOH·H₂O).

Typical examples of the phosphorus compound include phosphoric acid such as orthophosphoric acid (H₃PO₄), and ammonium hydrogen phosphate such as diammonium hydrogen phosphate ((NH₄)₂HPO₄) and ammonium dihydrogen phosphate (NH₄H₂PO₄).

Next, in Step S21c in FIG. 17, a solvent 805 is prepared. Water is preferably used as the solvent 805. Alternatively, a mixed solution of water and another liquid may be used as the solvent 805. For example, water and alcohol may be mixed. Here, the solubility of the lithium compound 803, the phosphorus compound 804, and a reaction product of the lithium compound 803 and the phosphorus compound 804 in water and the solubility thereof in alcohol are different Using alcohol makes the particle diameter of formed particles smaller in some in some cases. cases. Furthermore, by using alcohol, which has a lower boiling point than water, pressure can be easily increased in some cases in Step S83 described later.

Note that in the case where water is used as the solvent 805, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

Next, in Step S31 in FIG. 17, the lithium compound 803, the phosphorus compound 804, and the solvent 805 are mixed, whereby a mixture 811 of Step S32 is obtained. The mixing in Step S31 can be performed in an atmosphere of air, an inert gas, or the like. As the inert gas, nitrogen is used, for example. Here, as an example, the lithium compound 803 prepared in Step S21a, the phosphorus compound 804 prepared in Step S21b, and the solvent 805 prepared in Step S21c are mixed in an air atmosphere. For example, the lithium compound 803 prepared in Step S21a and the phosphorus compound 804 prepared in Step S21b are put in the solvent 805 prepared in Step S21c, whereby the mixture 811 of Step S32 is formed.

In the mixture 811 of Step S32 in FIG. 17, the lithium compound 803, the phosphorus compound 804, and the reaction product of the lithium compound and the phosphorus compound are precipitated in the solution in some cases; however, they are partly dissolved in the solvent without being precipitated, i.e., they partly exist as ions in the solvent. Here, when the mixture 811 has a low pH, the reaction product and the like may be easily dissolved in the solvent; when the mixture 811 has a high pH, the reaction product and the like may be easily precipitated.

Note that instead of forming the mixture 811 of Step S32 by mixing the lithium compound 803 and the phosphorus compound 804, the mixture 811 of Step S32 may be formed by preparing a compound containing phosphorus and lithium, such as Li₃PO₄, Li₂HPO₄, or LiH₂PO₄, and adding the compound to a solvent.

Here, in the case where the mixture 811 of Step S32 is an aqueous solution, the pH of the mixture 811 depends on the kind and dissociation degree of the salt included in the mixture 811. Accordingly, the pH of the mixture 811 changes depending on the lithium compound 803 and the phosphorus compound 804 used as the source materials. For example, in the case of using lithium chloride as the lithium compound 803 and orthophosphoric acid as the phosphorus compound 804, the mixture 811 of Step S32 is a strong acid. As another example, in the case of using lithium hydroxide monohydrate as the lithium compound 803, the mixture 811 of Step S32 is likely to be alkaline.

Next, in Step S33 in FIG. 17, a solution P 812 is prepared. Then, in Step S35, the mixture 811 of Step S32 and the solution P 812 prepared in Step S33 are mixed, whereby a mixture 821 of Step S41 is formed. Here, by adjusting the amount or concentration of the solution P 812 to be added, the pH of the obtained mixture 821 of Step S41 and a subsequently obtained mixture 831 of Step S82 can be adjusted. In Step S35, for example, the solution P 812 is dropped while the pH of the mixture 811 of Step S32 is measured. As the solution P 812, an alkaline solution or an acidic solution is used in accordance with the pH of the mixture 811 of Step S32. Here, by using a slightly alkaline or slightly acidic solution, the pH is easily adjusted in some cases. For example, the pH of the alkaline solution is greater than or equal to 8 and less than or equal to 12. Furthermore, the pH of the acidic solution is greater than or equal to 2 and less than or equal to 6. As the alkaline solution, ammonia water is used, for example. The pH and mixed amount of the solution P 812 are preferably determined so that the mixture 831 of Step S82, which is described later, becomes acidic or neutral.

Next, in Step S42 in FIG. 17, a transition metal M source 822 is prepared. As the transition metal M source 822, one or more of an iron (II) compound, a manganese (II) compound, a cobalt (II) compound, and a nickel (II) compound (hereinafter referred to as an M (II) compound) can be used.

Note that a high-purity material is preferably used as the transition metal M source used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a battery cell or increase the reliability of a battery cell.

In addition, it is preferred that the transition metal M source here have high crystallinity. For example, the transition metal source preferably includes single crystal grains. The crystallinity of the transition metal source can be evaluated with, for example, a TEM (transmission electron microscope) image, a STEM (scanning transmission electron microscope) image, a HAADF-STEM (high-angle annular dark field scanning transmission electron microscope) image, an ABF-STEM (annular bright-field scan transmission electron microscope) image, or the like. For evaluation of the crystallinity of the transition metal source, X-ray diffraction (XRD), electron diffraction, neutron diffraction, and the like can also be used for judging. Note that the above-described crystallinity evaluation can be applied not only to the transition metal source but also to a primary particle or a secondary particle.

Typical examples of the iron(II) compound include iron chloride tetrahydrate (FeCl₂.4H₂O), iron sulfate heptahydrate (FeSO₄.7H₂O), and iron acetate (Fe(CH₃COO)₂).

Typical examples of the manganese(II) compound include manganese chloride tetrahydrate (MnCl₂.4H₂O), manganese sulfate monohydrate (MnSO₄.H₂O), and manganese acetate tetrahydrate (Mn(CH₃COO)₂.4H₂O).

Typical examples of the cobalt (II) compound include cobalt chloride hexahydrate (CoCl₂.6H₂O), cobalt sulfate heptahydrate (CoSO₄.7H₂O), and cobalt acetate tetrahydrate (Co(CH₃COO)₂.4H₂O).

Typical examples of the nickel(II) compound include nickel chloride hexahydrate (NiCl₂.6H₂O), nickel sulfate hexahydrate (NiSO₄.6H₂O), and nickel acetate tetrahydrate (Ni(CH₃COO)₂.4H₂O).

Note that in Step S42, an aqueous solution of any of the above compounds may be prepared as the transition metal M source 822. In the case of preparing an aqueous solution of the compound, water to be used is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S41 in FIG. 17, the mixture 821 of Step S41 and the transition metal M source 822 are mixed, whereby the mixture 831 of Step S82 is obtained.

Here, in Step S41, the concentration of the mixture 831 of Step S82 can be reduced by addition of a solvent. For example, in Step S41, the mixture 821 of Step S41, the transition metal M source 822, and a solvent are mixed, whereby the mixture 831 of Step S82 can be formed.

Next, in Step S83 in FIG. 17, the mixture 831 of Step S82 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S44, the solution in the heat- and pressure-resistant container is filtered, followed by washing with water. Next, in Step S85, drying and subsequent collection are performed, whereby the positive electrode active material 90 of Step S86 is obtained. The positive electrode active material 90 can be referred to as a composite oxide.

The obtained positive electrode active material 90 can be denoted by LiMPO₄ (M is one or more of Fe(II), Ni(II), Co(II), and Mn(II)); specific examples of the positive electrode active material 90 include LiFePO₄ (LFP), LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is less than or equal to 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is less than or equal to 1, 0<c<1, 0<d<1, and 0<e<1), and LiFe_{f}Ni_{g}CoₕMn_{f}PO₄ (f+g+h+i is less than or equal to 1, 0<f<1, 0<g<1, 0<h<1, and 0<i<1). Among the above, LFP has a high level of safety and is suitable for an active material in an electric vehicle. Moreover, LLFP is inexpensive and thus is suitable for an active material in an electric vehicle.

The composite oxide obtained in this embodiment is preferable because of its high crystallinity. A composite oxide with high crystallinity can inhibit cycle deterioration and the like. The composite oxide may form single crystal grains.

By performing crystal analysis such as XRD or electron diffraction, for example, on the positive electrode active material 90, the crystal structure can be identified. For example, LiMPO₄ having an olivine crystal structure is identified as belonging to the space group Pnma.

As described above, although an example in which the positive electrode active material that can be used in the above embodiments is formed by a hydrothermal method is described in this embodiment, the present invention should not be construed as being limited to the above-described example.

This embodiment can be used in appropriate combination with the other embodiments.

### Embodiment 7

In this embodiment, a manufacturing method 3 of a positive electrode active material that can be used in the above embodiments is described. Unless otherwise specified, the manufacturing method 3 of the positive electrode active material described in this embodiment can be used for a battery for normal-temperature use or a battery for low-temperature use.

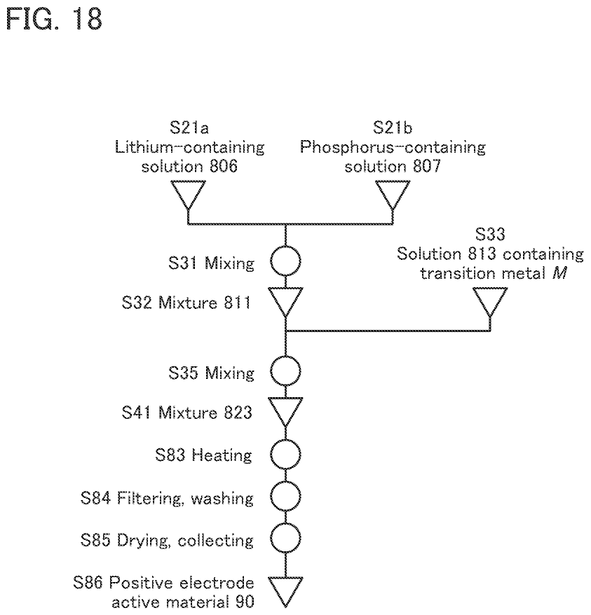

Specifically, a method for manufacturing a positive electrode active material by a liquid-phase method is described with reference to FIG. 18 and the like. The manufacturing method is described.

### Manufacturing Method 3 of Positive Electrode Active Material

In Step S21a in FIG. 18, a lithium-containing solution 806 is prepared. In Step S21b, a phosphorus-containing solution 807 is prepared.

The lithium-containing solution 806 can be formed by dissolving a lithium compound in a solvent. As the lithium compound, any one or more of lithium hydroxide monohydrate (LiOH.H₂O), lithium chloride (LiCl), lithium carbonate (Li₂CO₃), lithium acetate (CH₃COOLi), and lithium oxalate ((COOLi)₂) can be used. Water can be given as the solvent in which the lithium compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

The phosphorus-containing solution 807 can be formed by dissolving a phosphorus compound in a solvent. As the phosphorus compound, any one or more of phosphoric acid such as orthophosphoric acid (H₃PO₄) and ammonium hydrogen phosphate such as diammonium hydrogen phosphate ((NH₄)₂HPO₄) and ammonium dihydrogen phosphate (NH₄H₂PO₄) can be used. Water can be given as the solvent in which the phosphorus compound is dissolved. In the case where water is used as the solvent, it is preferably pure water that includes few impurities and preferably has a resistivity of 1 MΩ19 cm or higher, further preferably has a resistivity of 10 MΩ·cm or higher, and still further preferably has a resistivity of 15 MΩ·cm or higher. The use of a high-purity material can increase the capacity of a battery cell or increase the reliability of a battery cell.

Next, in Step S31 in FIG. 18, the lithium-containing solution 806 and the phosphorus-containing solution 807 are mixed, whereby the mixture 811 of Step S32 is obtained. The mixing in Step S31 can be performed in an atmosphere of air, an inert gas, or the like. As the inert gas, nitrogen is used, for example. Here, as an example, the lithium-containing solution 806 prepared in Step S21a and the phosphorus-containing solution 807 prepared in Step S21b are mixed in an air atmosphere.

Note that instead of forming the mixture 811 of Step S32 by mixing the lithium-containing solution 806 and the phosphorus-containing solution 807, the mixture 811 of Step S32 may be formed by preparing a compound containing phosphorus and lithium, such as Li₃PO₄, Li₂HPO₄, or LiH₂PO₄, and adding the compound to a solvent.

Next, in Step S33 in FIG. 18, a solution 813 containing the transition metal M is prepared.

The solution 813 containing the transition metal M can be formed by dissolving a transition metal M compound in a solvent. As the transition metal M compound, one or more of an iron (II) compound, a manganese (II) compound, a cobalt (II) compound, and a nickel (II) compound (hereinafter referred to as an M (II) compound) can be used. Water can be given as the solvent in which the transition metal M compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a battery cell or increase the reliability of a battery cell.

Note that a high-purity material is preferably used as the transition metal M compound used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a battery cell or increase the reliability of a battery cell.

In addition, it is preferred that the transition metal M compound here have high crystallinity. For example, the transition metal compound preferably includes single crystal grains. The crystallinity of the transition metal compound can be evaluated with, for example, a TEM (transmission electron microscope) image, a STEM (scanning transmission electron microscope) image, a HAADF-STEM (high-angle annular dark field scanning transmission electron microscope) image, an ABF-STEM (annular bright-field scan transmission electron microscope) image, or the like. For evaluation of the crystallinity of the transition metal M compound, X-ray diffraction (XRD), electron diffraction, neutron diffraction, and the like can also be used for judging. Note that the above-described crystallinity evaluation can be applied not only to the transition metal M compound but also to a primary particle or a secondary particle.

Typical examples of the iron (II) compound include iron chloride tetrahydrate (FeCl₂.4H₂O), iron sulfate heptahydrate (FeSO₄.7H₂O), and iron acetate (Fe(CH₃COO)₂).

Typical examples of the manganese (II) compound include manganese chloride tetrahydrate (MnCl₂.4H₂O), manganese sulfate monohydrate (MnSO₄.H₂O), and manganese acetate tetrahydrate (Mn(CH₃COO)₂.4H₂O).

Typical examples of the cobalt (II) compound include cobalt chloride hexahydrate (CoCl₂.6H₂O), cobalt sulfate heptahydrate (CoSO₄.7H₂O), and cobalt acetate tetrahydrate (Co(CH₃COO)₂.4H₂O).

Typical examples of the nickel (II) compound include nickel chloride hexahydrate (NiCl₂.6H₂O), nickel sulfate hexahydrate (NiSO₄.6H₂O), and nickel acetate tetrahydrate (Ni(CH₃COO)₂.4H₂O).

Next, in Step 35 in FIG. 18, the mixture 811 of Step S32 and the solution 813 containing the transition metal M are mixed, whereby a mixture 823 of Step S41 is obtained.

Here, the atomic ratio of lithium to a transition metal M and phosphorus of a composite oxide that is preferably obtained as an after-mentioned positive electrode active material 90 is x:y:z. In order to obtain LiMPO₄, for example, x:y:z=1:1:1 is satisfied.

In a method for the mixing in Step S35 in FIG. 18, the solution 813 containing the transition metal M is dropped little by little into the mixture 811 of Step S32 that is put in a container, whereby the mixture 823 of Step S41 can be formed. In the mixing, it is preferred that the solution in the container and the solution used for the mixing be being stirred, and it is also preferred that dissolved oxygen be removed by N₂ bubbling.

Alternatively, in a method for the mixing in Step S35 in FIG. 18, the mixture 811 of Step S32 is dropped little by little into the solution 813 containing the transition metal M that is put in a container, whereby the mixture 823 of Step S41 can be formed. In the mixing, it is preferred that the solution in the container and the solution used for the mixing be being stirred, and it is also preferred that dissolved oxygen be removed by N₂ bubbling.

Here, in Step S35, the concentration of the mixture 823 of Step S41 can be adjusted by addition of a solvent. For example, in Step S35, the mixture 811 of Step S32, the solution 813 containing the transition metal M, and a solvent are mixed, whereby the mixture 823 of Step S41 can be formed. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S83 in FIG. 18, the mixture 823 of Step S41 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S44, the solution in the heat-and pressure-resistant container is filtered, followed by washing with water. Next, in Step S85, drying and subsequent collection are performed, whereby the positive electrode active material 90 of Step S86 is obtained. The positive electrode active material 90 can be referred to as a composite oxide.

The obtained positive electrode active material 90 can be denoted by LiMPO₄ (M is one or more of Fe(II), Ni(II), Co(II), and Mn(II)); specific examples of the positive electrode active material 90 include LiFePO₄ (LFP), LiNiPO₄, LiCoPO₄, LiMnPO₄, LiFeₐNi_{b}PO₄, LiFeₐCo_{b}PO₄, LiFeₐMn_{b}PO₄, LiNiₐCO_{b}PO₄, LiNiₐMn_{b}PO₄ (a+b is less than or equal to 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is less than or equal to 1, 0<c<1, 0<d<1, and 0<e<1), and LiFe_{f}Ni_{g}CoₕMnᵢPO₄ (f+g+h+i is less than or equal to 1, 0<f<1, 0<g<1, 0<h<1, and 0<i<1). Among the above, LFP has a high level of safety and is suitable for an active material in an electric vehicle. Moreover, LFP is inexpensive and thus is suitable for an active material in an electric vehicle.

The composite oxide obtained in this embodiment is preferable because of its high crystallinity. A composite oxide with high crystallinity can inhibit cycle deterioration and the like. The composite oxide may form single crystal grains.

By performing crystal analysis such as XRD or electron diffraction, for example, on the positive electrode active material 90, the crystal structure can be identified. For example, LiMPO₄ having an olivine crystal structure is identified as belonging to the space group Pnma.

As described above, although an example in which the positive electrode active material that can be used in the above embodiments is formed by a hydrothermal method is described in this embodiment, the present invention should not be construed as being limited to the above-described example.

This embodiment can be used in appropriate combination with the other embodiments.

### Embodiment 8

In this embodiment, an all-solid-state battery is described as a battery cell that can be used in the above embodiments. Unless otherwise specified, the all-solid-state battery containing the positive electrode active material described in this embodiment can be used for a battery for normal-temperature use or a battery for low-temperature use.

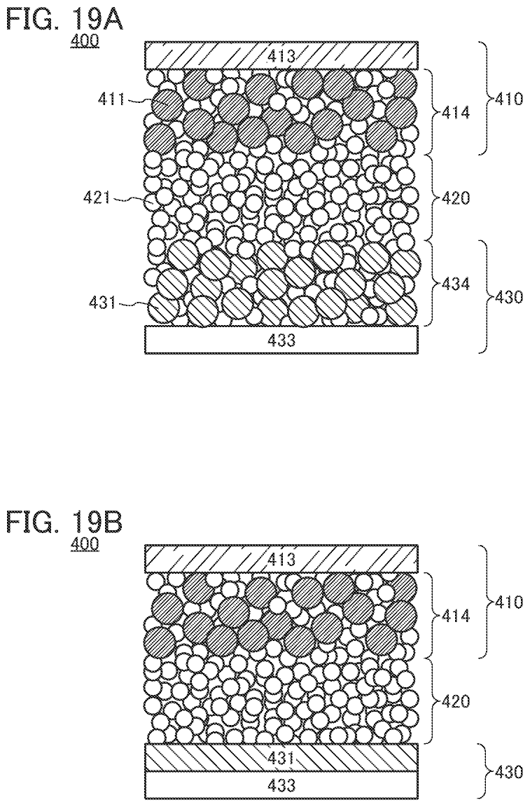

As illustrated in FIG. 19A, a battery cell 400 of one embodiment of the present invention is an all-solid-state battery and includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material layer 414 may include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 19B. The use of metal lithium for the negative electrode 430 is preferable because of increasing the energy density of the battery cell 400.

As the solid electrolyte 421 included in the solid electrolyte layer 420, a sulfide-based solid electrolyte, an oxide-based solid electrolyte, or a halide-based solid electrolyte can be used, for example.

As already described above, the sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S.30P₂S530Li₂S.26B₂S₃.44LiI, 63Li₂S.36SiS₂.1Li₃PO₄, 57Li₂S.38SiS₂.5Li₄SiO₄, or 50Li₂S.50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

As already described above, the oxide-based solid electrolyte includes a material with a perovskite crystal structure (e.g., La_{2/3-x}Li₃ₓTiO₃), a material with a NASICON crystal structure (e.g., Li_{1+Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄.50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

As already described above, examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

As already described above, Li₁₊ₓAlₓTi₂₋ₓ(PO₄)₃ (0[x[1) having a NASICON crystal structure (hereinafter, LATP) is preferable because it contains aluminum and titanium, each of which is the element the positive electrode active material used in the battery cell of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share corners are arranged three-dimensionally.

This embodiment can be used in appropriate combination with the other embodiments.

### Embodiment 9

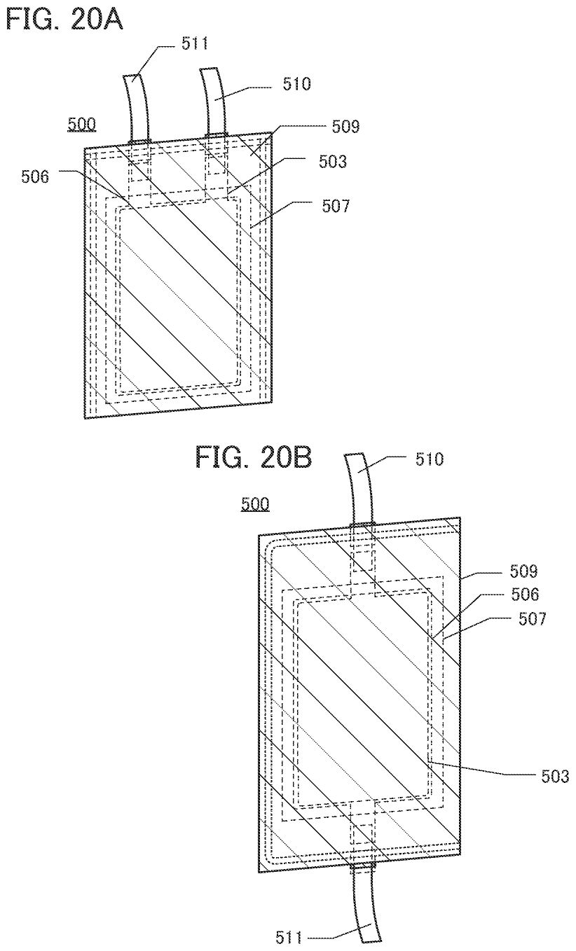

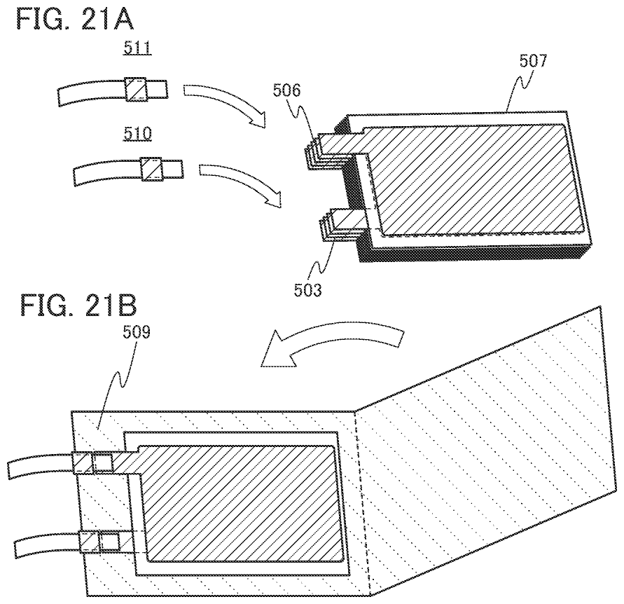

In this embodiment, other structure examples of the battery cell are described with reference to FIG. 20A, FIG. 20B, FIG. 21A, and FIG. 21B. Unless otherwise specified, the other structure examples of the battery cell described in this embodiment can be used for a battery for normal-temperature use or a battery for low-temperature use.

### Laminated Battery Cell

A secondary battery 500 illustrated in FIG. 20A and FIG. 20B is a laminated battery cell. In FIG. 20A and FIG. 20B, a positive electrode 503, a negative electrode 506, a separator 507, an exterior body 509, a positive electrode lead electrode 510, and a negative electrode lead electrode 511 are included.

FIG. 20A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 20A.

### Manufacturing Method of Laminated Battery Cell

An example of a method for manufacturing the laminated battery cell whose external view is illustrated in FIG. 20A is described with reference to FIG. 21A and FIG. 21B.

First, the negative electrode 506, the separator 507, and the positive electrode 503 are stacked as illustrated in FIG. 21A. Here, an example in which five negative electrodes and four positive electrodes are used is shown. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 21B. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated battery cell can be formed.

This embodiment can be used in appropriate combination with the other embodiments.

### Embodiment 10

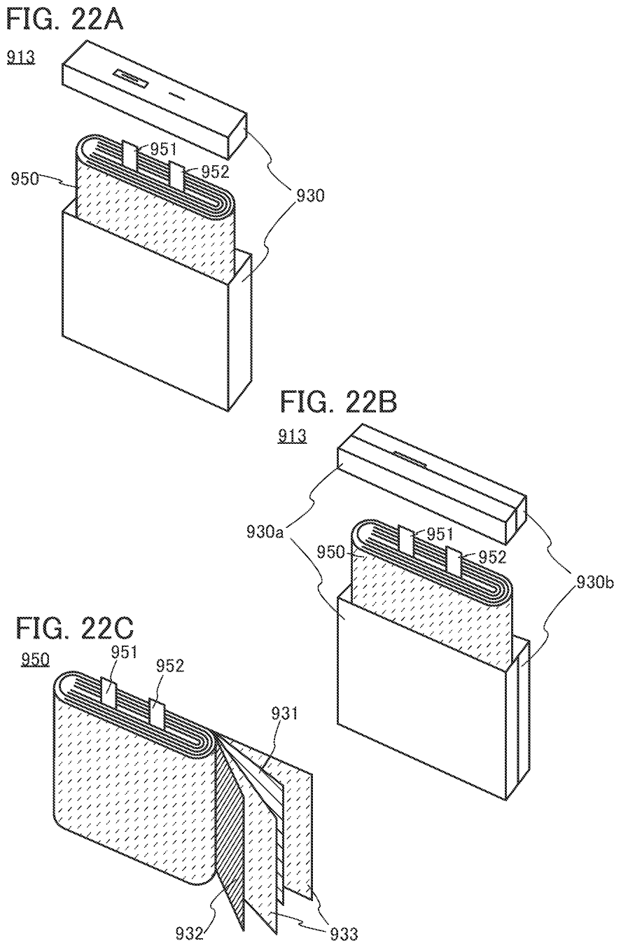

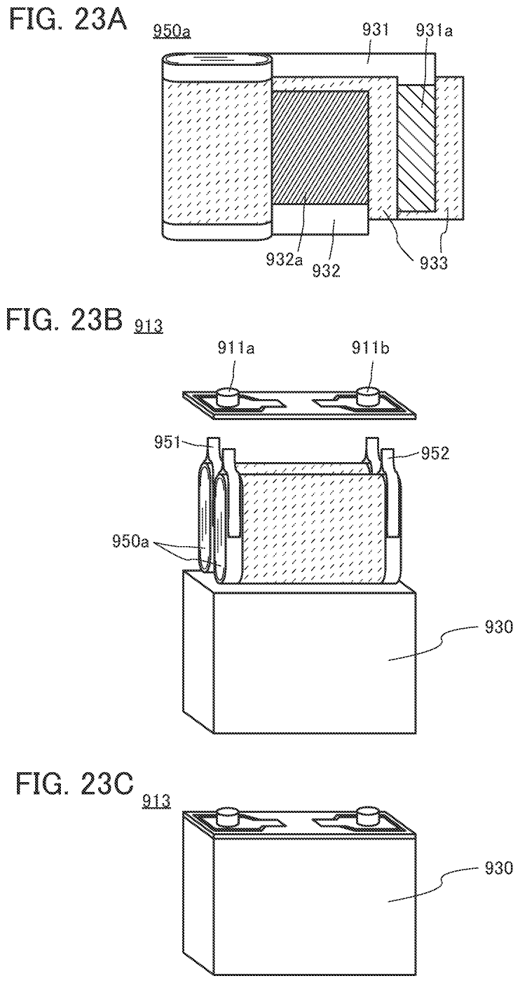

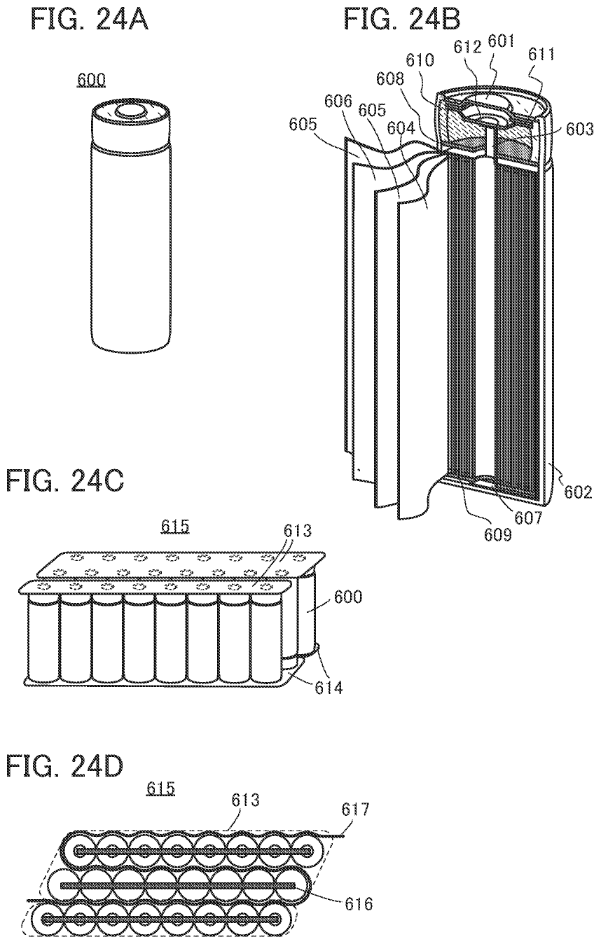

In this embodiment, other structure examples of the battery cell are described with reference to FIG. 22A to FIG. 22C, FIG. 23A to FIG. 23C, and FIG. 24A to FIG. 24D. Unless otherwise specified, the other structure examples of the battery cell described in this embodiment can be used for a battery for normal-temperature use or a battery for low-temperature use.

### Rectangular Battery Cell

A secondary battery 913 illustrated in FIG. 22A is a rectangular battery cell and includes a wound body 950 provided with a terminal 951 and a terminal 952 inside a housing 930. The wound body 950 is soaked in an electrolyte solution in a region inside the housing 930. The terminal 952 is in contact with the housing 930. An insulator or the like prevents contact between the terminal 951 and the housing 930. In FIG. 22A, the housing 930 divided into pieces is shown for convenience; however, in the actual structure, the wound body 950 is covered with the housing 930 and the terminal 951 and the terminal 952 extend to the outside of the housing 930. For the housing 930, a metal material (e.g., aluminum or the like) or a resin material can be used.

As illustrated in FIG. 22B, the housing 930 illustrated in FIG. 22A may be formed using a plurality of materials. For example, in the secondary battery 913 illustrated in FIG. 22B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 22C illustrates a structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 23A to FIG. 23C, the secondary battery 913 being the rectangular battery cell may include a wound body 950a. The wound body 950a illustrated in FIG. 23A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 23B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 23C, the wound body 950a and an electrolyte solution are covered with the housing 930, whereby the secondary battery 913 is obtained. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 23B, the secondary battery 913 may include a plurality of wound bodies 950a. The use of the plurality of wound bodies 950a enables the secondary battery 913 to have higher charge/discharge capacity. The description of the secondary battery 913 illustrated in FIG. 22A to FIG. 22C can be referred to for the other components of the secondary battery 913 illustrated in FIG. 23A and FIG. 23B.

### Cylindrical Battery Cell

A secondary battery 600 illustrated in FIG. 24A is a cylindrical battery cell. FIG. 24B is a schematic cross-sectional view of the secondary battery 600. The secondary battery 600 includes, as illustrated in FIG. 24B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-shaped positive electrode 604 and a strip-shaped negative electrode 606 are wound with a strip-shaped separator 605 located therebetween is provided. Although not illustrated, the battery element is wound around a center pin. One end of the battery can 602 is closed and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separators are wound is provided between a pair of insulating plates 608 and 609 that face each other. Furthermore, a nonaqueous electrolyte solution (not illustrated) is injected in a region inside the battery can 602 where the battery element is provided.

Since a positive electrode and a negative electrode are wound in a cylindrical battery cell, active materials are preferably formed on both surfaces of current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (PosiTive TemperaTure CoefficienT) 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as the temperature rises, limits the amount of current by increasing the resistance, in order to prevent abnormal heat generation. Barium titanate (BaTiO₃)-based semiconductor ceramic or the like can be used for the PTC element.

As illustrated in FIG. 24C, a plurality of secondary batteries 600 may be provided between a conductive plate 613 and a conductive plate 614 to form an assembled battery 615. The plurality of secondary batteries 600 may be connected in parallel, connected in series, or connected in series after being connected in parallel. With the assembled battery 615 including the plurality of secondary batteries 600, large power can be extracted. The battery pack can include the assembled battery 615, a BMU, a temperature sensor, and the like.

FIG. 24D is a top view of the assembled battery 615. The conductive plate 613 is shown by a dotted line for clarity of the drawing. As illustrated in FIG. 24D, the assembled battery 615 may include a wiring 616 electrically connecting the plurality of secondary batteries 600 with each other. It is possible to provide the conductive plate over the wiring 616 so that they overlap with each other. In addition, a cooling device 617 serving as a temperature control device may be provided between the plurality of secondary batteries 600. When the secondary batteries 600 are overheated, the secondary batteries 600 can be cooled with the cooling device 617. When a warming device is used as the temperature control device, too cold secondary batteries 600 can be heated. Thus, the performance of the assembled battery 615 is unlikely to be affected by the outside temperature.

This embodiment can be used in appropriate combination with the other embodiments.

### Embodiment 11

In this embodiment, examples of a vehicle or the like provided with the battery control system that is one embodiment of the present invention or the like are described.

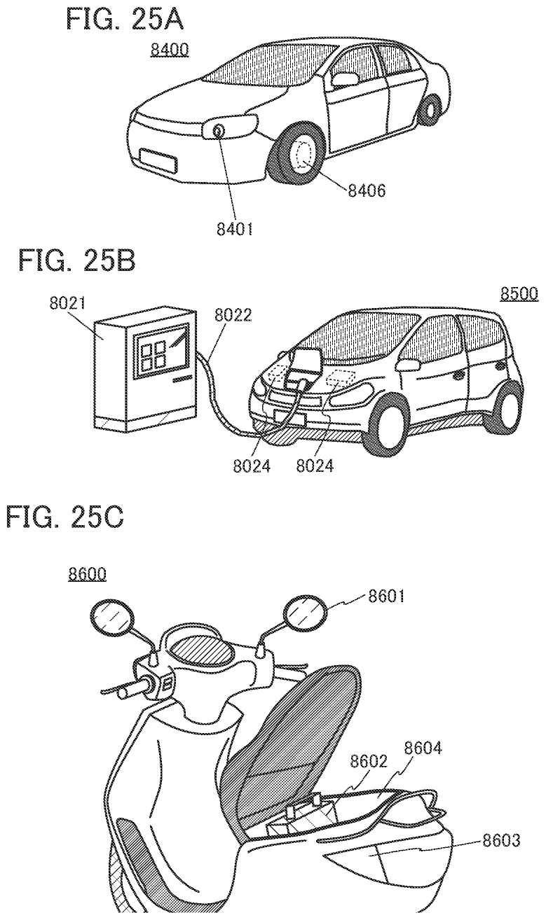

FIG. 25A to FIG. 25C illustrate examples of vehicles each using the secondary battery of one embodiment of the present invention. An automobile 8400 illustrated in FIG. 25A is an electric vehicle that moves on the power of an electric motor. Alternatively, the automobile 8400 is a hybrid vehicle capable of moving appropriately using either an electric motor or an engine as a power source. The use of one embodiment of the present invention can achieve a high-mileage vehicle. The automobile 8400 includes the secondary battery. The secondary battery can be used not only for driving an electric motor 8406, but also for supplying power to a light-emitting device such as a headlight 8401 or a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 25B can be charged when a secondary battery included in the automobile 8500 is supplied with power from external charging equipment by a plug-in system, a contactless power feeding system, or the like. FIG. 25B illustrates a state where a secondary battery 8024 provided in the automobile 8500 is charged from a ground installation type charging apparatus 8021 through a cable 8022. The charging apparatus 8021 may be a charging station provided in a commerce facility or a power source in a house. For example, with the use of a plug-in technique, the secondary battery 8024 provided in the automobile 8500 can be charged by being supplied with power from outside. The charging can be performed by converting AC power into DC power through a converter such as an ACDC converter.

Although not illustrated, the vehicle may be provided with a power receiving device so that it can be charged by being supplied with power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of power between vehicles. Furthermore, a solar cell may be provided in the exterior of the vehicle to charge the secondary battery when the vehicle is stopping or moving. To supply power in such a contactless manner, an electromagnetic induction method or a magnetic resonance method can be used.

In addition, FIG. 25C is an example of a motorcycle using a secondary battery of one embodiment of the present invention. A motor scooter 8600 illustrated in FIG. 25C includes a secondary battery 8602, side mirrors 8601, and direction indicators 8603. The secondary battery 8602 can supply electricity to the direction indicators 8603.

Furthermore, in the motor scooter 8600 illustrated in FIG. 25C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

When the above-described vehicle is provided with the battery control system of one embodiment of the present invention, the battery can be efficiently used and a next-generation clean energy vehicle can be achieved.

This embodiment can be implemented in appropriate combination with the other embodiments.

### REFERENCE NUMERALS

10: battery control system, 101: driving battery, 101a: battery, 101b: battery, 102: temperature sensor, 103a: circuit, 103b: circuit 112: BMU, 105: DCDC circuit, 105a: DCDC circuit, 105b: DCDC circuit

1. A battery control system comprising:
a first battery that can be charged and discharged in a first temperature range;
a second battery that can be charged and discharged in a second temperature range;
a first circuit being electrically connected to the first battery and comprising a first transformer;
a second circuit being electrically connected to the second battery and comprising a second transformer; and
a temperature sensor configured to detect a temperature of the first battery and the second battery,
wherein when the temperature detected with the temperature sensor is higher than or equal to Tr, power of the second battery is transferred to the first battery by the first circuit and the second circuit,
wherein when the temperature detected with the temperature sensor is lower than the Tr, power of the first battery is transferred to the second battery by the first circuit and the second circuit,
wherein an upper limit of the first temperature range is higher than an upper limit of the second temperature range,
wherein a lower limit of the first temperature range is lower than the upper limit of the second temperature range,
wherein a lower limit of the second temperature range is lower than the lower limit of the first temperature range, and
wherein the Tr satisfies a range higher than the lower limit of the first temperature range and lower than the upper limit of the second temperature range.

2. A battery control system comprising:
a first battery that can be charged and discharged in a first temperature range;
a second battery that can be charged and discharged in a second temperature range;
a first DCDC circuit electrically connected to the first battery;
a second DCDC circuit electrically connected to the second battery; and
a temperature sensor configured to detect a temperature of the first battery and the second battery,
wherein when the temperature detected with the temperature sensor is higher than or equal to Tr, an output from the first battery is set higher than an output from the second battery by the first DCDC circuit,
wherein when the temperature detected with the temperature sensor is lower than the Tr, the output from the second battery is set higher than the output from the first battery by the second DCDC circuit,
wherein an upper limit of the first temperature range is higher than an upper limit of the second temperature range,
wherein a lower limit of the first temperature range is lower than the upper limit of the second temperature range,
wherein a lower limit of the second temperature range is lower than the lower limit of the first temperature range, and
wherein the Tr satisfies a range higher than the lower limit of the first temperature range and lower than the upper limit of the second temperature range.

3. A battery control system comprising:
a first battery that can be charged and discharged in a first temperature range;
a second battery that can be charged and discharged in a second temperature range;
a first circuit being electrically connected to an input side of the first battery and comprising a first transformer;
a second circuit being electrically connected to an input side of the second battery and comprising a second transformer;
a first DCDC circuit electrically connected to an output side of the first battery;
a second DCDC circuit electrically connected to an output side of the second battery; and
a temperature sensor configured to detect a temperature of the first battery and the second battery,
wherein when the temperature detected with the temperature sensor is higher than or equal to Tr, an output from the first battery is set higher than an output from the second battery by the first DCDC circuit,
wherein when the temperature detected with the temperature sensor is lower than the Tr, the output from the second battery is set higher than the output from the first battery by the second DCDC circuit,
wherein when the temperature detected with the temperature sensor is higher than or equal to the Tr, power of the second battery is transferred to the first battery by the first circuit and the second circuit,
wherein when the temperature detected with the temperature sensor is lower than the Tr, power of the first battery is transferred to the second battery by the first circuit and the second circuit,
wherein an upper limit of the first temperature range is higher than an upper limit of the second temperature range,
wherein a lower limit of the first temperature range is lower than the upper limit of the second temperature range,
wherein a lower limit of the second temperature range is lower than the lower limit of the first temperature range, and
wherein the Tr satisfies a range higher than the lower limit of the first temperature range and lower than the upper limit of the second temperature range.

4. The battery control system according to claim 1,
wherein a discharge capacity value of the second battery in discharge at the lower limit of the second temperature range is higher than or equal to 50% of a discharge capacity value of the second battery in discharge at 25° C.

5. The battery control system according to claim 1,
wherein the first battery is a lithium-ion battery and the second battery is a sodium-ion battery.

6. The battery control system according to claim 1,
wherein a positive electrode active material of the first battery has a layered rock-salt crystal structure and a positive electrode active material of the second battery has an olivine crystal structure.

7. The battery control system according to claim 1,
wherein a positive electrode active material of the first battery contains Li, Ni, Co, and Mn and a positive electrode active material of the second battery contains Li, Fe, and phosphorus.

8. The battery control system according to claim 1,
wherein a median diameter of a positive electrode active material of the second battery is smaller than a median diameter of a positive electrode active material of the first battery.

9. The battery control system according to claim 1,
wherein an electrolyte of the second battery is different from an electrolyte of the first battery,
wherein the electrolyte of the second battery contains ethylene carbonate (EC), ethyl methyl carbonate (EMC), and dimethyl carbonate (DMC), and
wherein when a total content of the ethylene carbonate, the ethyl methyl carbonate, and the dimethyl carbonate is 100 vol %, a volume ratio between the ethylene carbonate, the ethyl methyl carbonate, and the dimethyl carbonate is x:y:100−x−y (where 5≤x≤35 and 0<y<65).

10. A vehicle comprising the battery control system according to claim 1.

11. The battery control system according to claim 2,
wherein a discharge capacity value of the second battery in discharge at the lower limit of the second temperature range is higher than or equal to 50% of a discharge capacity value of the second battery in discharge at 25° C.

12. The battery control system according to claim 2,
wherein the first battery is a lithium-ion battery and the second battery is a sodium-ion battery.

13. The battery control system according to claim 2,
wherein a positive electrode active material of the first battery has a layered rock-salt crystal structure and a positive electrode active material of the second battery has an olivine crystal structure.

14. The battery control system according to claim 2,
wherein a positive electrode active material of the first battery contains Li, Ni, Co, and Mn and a positive electrode active material of the second battery contains Li, Fe, and phosphorus.

15. The battery control system according to claim 2,
wherein a median diameter of a positive electrode active material of the second battery is smaller than a median diameter of a positive electrode active material of the first battery.

16. The battery control system according to claim 2,
wherein an electrolyte of the second battery is different from an electrolyte of the first battery,
wherein the electrolyte of the second battery contains ethylene carbonate (EC), ethyl methyl carbonate (EMC), and dimethyl carbonate (DMC), and
wherein when a total content of the ethylene carbonate, the ethyl methyl carbonate, and the dimethyl carbonate is 100 vol %, a volume ratio between the ethylene carbonate, the ethyl methyl carbonate, and the dimethyl carbonate is x:y:100−x−y (where 5≤x≤35 and 0<y<65).

17. A vehicle comprising the battery control system according to claim 2.

18. The battery control system according to claim 3,
wherein a discharge capacity value of the second battery in discharge at the lower limit of the second temperature range is higher than or equal to 50% of a discharge capacity value of the second battery in discharge at 25° C.

19. The battery control system according to claim 3,
wherein the first battery is a lithium-ion battery and the second battery is a sodium-ion battery.

20. The battery control system according to claim 3,
wherein a positive electrode active material of the first battery has a layered rock-salt crystal structure and a positive electrode active material of the second battery has an olivine crystal structure.

21. The battery control system according to claim 3,
wherein a positive electrode active material of the first battery contains Li, Ni, Co, and Mn and a positive electrode active material of the second battery contains Li, Fe, and phosphorus.

22. The battery control system according to claim 3,
wherein a median diameter of a positive electrode active material of the second battery is smaller than a median diameter of a positive electrode active material of the first battery.

23. The battery control system according to claim 3,
wherein an electrolyte of the second battery is different from an electrolyte of the first battery,
wherein the electrolyte of the second battery contains ethylene carbonate (EC), ethyl methyl carbonate (EMC), and dimethyl carbonate (DMC), and
wherein when a total content of the ethylene carbonate, the ethyl methyl carbonate, and the dimethyl carbonate is 100 vol %, a volume ratio between the ethylene carbonate, the ethyl methyl carbonate, and the dimethyl carbonate is x:y:100−x−y (where 5≤x≤35 and 0<y<65).

24. A vehicle comprising the battery control system according to claim 3.
